(19) United States
(12) Patent Application Publication
(10) Pub. No.: US 2005/0132305 A1
(43) Pub. Date: Jun. 16, 2005

(54) Electronic information access systems, methods for creation and related commercial models

(76) Inventors: Robert Daniel Guichard, San Francisco, CA (US); Justin Charles Gordon, Austin, TX (US); Patrick Man Wai Law, Seattle, WA (US)

Correspondence Address: Robert Daniel Guichard, 1578 - 35th Avenue, San Francisco, CA, 94122, US

(21) Appl. No.: 10/734,397

(22) Filed: Dec. 12, 2003

(51) Int. Cl. G06F 3/00

(52) U.S. Cl. 715/855; 715/850

(57) ABSTRACT

The present invention relates to electronic information access systems, methods of creation and related commercial models. Additionally, a mouse over navigation interface is provided for user selectable viewing of a desired display.

### BACKGROUND OF THE INVENTION

Evolution of electronic information has resulted in voluminous archives of electronic data. It should be understood that as used herein, the term “electronic information” includes “electronic data” and the term “electronic data” includes “electronic information”.

Individuals are commonly sending and receiving email messages; documenting their lives with digital pictures, audio recordings and home video; typing letters and reports; dealing with financial matters; planning recreation; creating electronic directories of family, friends and associates; and creating the occasional holiday letter. Closely held corporations, international corporations, individual countries, states, counties, townships and local municipalities are creating massive amounts of electronic information.

Arguably, the greatest proliferation of data in the history of the world has taken place on the internet. Millions of web sites and billions of web pages have been created and many more are being created each day. Typically, electronic information is not “structured” nor is there typically an “intrinsic order.

Personal digital assistants (PDAs), stand alone personal computers, cameras, video recorders, audio recorders, video players, audio players, direct video device (DVD) players, DVD recorders, network servers, main frames, terminals, intranets, email, internets, cellular telephones, pagers, as well as, a seemingly endless list of physical data storage mediums such as floppy disks, hard disks, compact disks (CDs), DVDs, zip drives, tapes, media players (MPs, such as MP3s), memory chips, memory sticks, USB compatible key chain size memory, etc. are available for creating, storing and disseminating electronic information.

As individuals, community members, employees, shareholders and customers we are all impacted by the inevitable migration to the electronic information age. Locating, accessing and utilizing all of this electronic information sometimes presents a daunting task. This is especially true with regard to non-structured electronic information not having an intrinsic order.

Indeed, the electronic information age has spawned cottage industries, of sorts, providing products and services aimed at various aspects of creating, manipulating, storing, locating, accessing, retrieving, utilizing and disseminating associated electronic files. Unlike the nearly universally utilized Dewey decimal system for locating items in physical libraries, a diverse array of “standards” have been introduced for accessing electronic information.

Some of the more common electronic information “search engines” and search technology providers such as AOL, Northern Light, Yahoo, Google, AlltheWeb, Infoseek, Teoma, AltaVista, AskJeeves, HotBot, Inktomi, LookSmart, Lycos, FAST, Overture, About.com, Roadrunner, MSN search engines, FindWhat.com, E-spotting, Search.com, InfoSpace, WebFountain (from IBM), A9.com, for example, employ “key word”, word and, or, text based searching as human interface options for access to associated electronic information. Incorporation of “Boolean” connector (such as “and”, “or”, “not”, etc.) functionality and, or, “wild characters” (such as an * or $) have proven beneficial. It is common for browsers, such as Netscape, Internet Explorer, OPERA, Safari, K Desktop Environment (KDE), MSN, R d Hat, SuSE, and Mozilla, for example, to incorporate an interface, or, interfaces, to one or more of these search engines. Contemporary with filing of this application for patent, IBM, Microsoft and Amazon are actively pursuing search engine technology and many of the individual search engines listed herein are “in transition.”

More recently, “concept maps” (commonly referred to as “mind maps,” “conceptual maps,” “c-maps,” “visual maps,” “visual data maps” and “space diagrams”) are being employed, sometimes in combination with “structured information” and, or, “intrinsic order” techniques, to facilitate human interface to electronic information. “Expert systems” based on concept map(s) are being deployed to impart structure and a more intrinsic order to related electronic information via a “decision tree” or the like.

What is needed is an improved electronic information access system that facilitates quick and efficient acquisition of desired information utilizing universally accepted operating systems, related hardware, firmware and software. A means for encouraging exploration and discovery of electronic information is also needed. A related commercial model is needed for perpetuating an ongoing revision process to insure relevance and to adapt to evolving computer hardware, firmware and software. An EIAS that imparts structure and, or, intrinsic order to non-structured electronic information and, or, electronic information having no intrinsic order is also needed.

### SUMMARY OF THE INVENTION

The present invention provides improved electronic information access systems (EIASs). EIASs are provided that facilitate quick and efficient acquisition of desired electronic information and accommodate universally accepted operating systems, related hardware, firmware and software. Commercial models are provided for facilitating ongoing revision to insure relevance and to adapt to evolving computer hardware, firmware and software. EIASs are provided that encourage exploration and discovery of electronic information. Some EIASs of the present invention are configured to impart structure and, or, intrinsic order to non-structured electronic information and, or, electronic information with no intrinsic order. In other EIAS embodiments, various features are integrated in various combinations.

In at least one embodiment, a concept map is provided for presenting a body of information (“subject domain”) to a viewer. In a related embodiment, only a portion of the overall concept map is visible at a given time. In another related embodiment, a “GO TO” button is provided to move between subject topics and, or, sub-subject topics within a concept map. In yet another related embodiment, a return to center button is provided to allow the concept map to be returned to its original default position with respect to a viewing window. Although the default position of the concept map is preferably located near the center; it is also possible that it could be on the top or bottom or anywhere else on the concept map. In a related embodiment, an area is provided adjacent to the concept map viewing window for visual display of advertising and, or, sponsorship banners.

In at least one embodiment, a multi-directional navigation interface is provided for repositioning a related concept map with respect to an associated viewing window. In a related embodiment, a “mouse over” multi-directional navigation interface is provided. In another related embodiment, a multi-directional navigation interface is provided with at least partially clickable selection functionality. In another related embodiment, a distinct border is placed at least partially surrounding a concept map to indicate to a user that a map edge has been encountered as a result of the concept map moving with respect to a viewing window.

In at least one embodiment, a database is provided for storing electronic information links. In a related embodiment, electronic information links are pre-screened to provide the best, most credible and relevant information. In another related embodiment, information links pages are provided to facilitate presentation of electronic information to a user. In a related embodiment, information links pages are provided with data; collaborative data, such as research observations, investigative leads or tips; information links; or any combination thereof. In yet another related embodiment, the EIAS is configured with dynamic information links pages.

In at least one embodiment, an EIAS is provided that utilizes an International Business Machines (IBM) compatible computer system. In a related embodiment, an EIAS is provided that utilizes an Apple Incorporated compatible computer system. In another related embodiment, an EIAS is provided that utilizes a plurality of computers and, or, terminals interconnected. In yet another related embodiment, at least one server and, or, a mainframe computer is provided for implementation of the related EIAS. In still another related embodiment, an EIAS is provided that employs, either individually or in combination with one another, Microsoft Windows NT, Novell, Microsoft Windows, OS2, Apple operating system, Mac OS X, UNIX, Linex, Cisco, disk operating system (DOS), etc. software.

In at least one embodiment, the EIAS is at least partially implemented utilizing FLASH software and, or, Action Script, from Macromedia, Corporation. In a related embodiment, the EIAS is at least partially implemented utilizing JAVA software and, or, JAVA Script. In another related embodiment, the EIAS is at least partially implemented utilizing HTML and, or, KHTML code. In yet another related embodiment, COLDFUSION software and, or, COLDFUSION mark-up language (CFML), from Macromedia, Corporation, is utilized to implement at least a portion of an EIAS. In still another related embodiment, an EIAS is at least partially implemented utilizing Microsoft SQL server software with an ODBC.

In yet another related embodiment, the EIAS provides accelerated loading when utilized via an internet connection and, or, a network; the network may be a local area network, a wide area network, an intranet or a combination thereof. In a related embodiment, an EIAS provides accelerated loading on a stand alone computer.

Additional features, functionality and commercial models associated with the EIASs of the present invention will become apparent while reading the detail description in light of the accompanying drawings and appended claims.

### BRIEF DESCRIPTION OF THE DRAWINGS

FIG. 1 depicts a concept map based visual interface of an EIAS running within Netscape;

FIG. 2 depicts an alternate embodiment of a concept based visual interface of an EIAS having advertising banners running within Netscape;

FIGS. 3a-3e depict various concept maps;

FIG. 4 depicts an embodiment of an EIAS;

FIG. 5 depicts an eight-way navigation interface of an EIAS;

FIG. 6 depicts a selected sub-subject topic of an EIAS;

FIG. 7 depicts an information links page associated with the sub-subject topic of FIG. 6;

FIG. 8 depicts a concept map with a border;

FIG. 9 depicts a selected “GO TO” button of an EIAS;

FIG. 10 depicts the results of activating the “GO TO” button of FIG. 8;

FIG. 11 depicts a selected “return to center” button of an EIAS;

FIG. 12 depicts the results of activating the “return to center” button of FIG. 11 along with a selected “About” button;

FIG. 13 depicts a selected Netscape “Page Source” menu item;

FIG. 14 depicts the results of activating the “Page Source” menu item of FIG. 11;

FIG. 15 depicts a FLASH document properties screen;

FIG. 16 depicts a FLASH timeline screen;

FIG. 17 depicts a FLASH development screen;

FIG. 18 depicts a FLASH publish settings screen;

FIG. 19 depicts a FLASH action-frame screen;

FIG. 20 depicts a FLASH development screen related to an eight-way navigation interface;

FIG. 21 depicts a FLASH publish settings screen;

FIG. 22 depicts a database screen listing; and

FIG. 23 depicts a second database screen listing details associated with a given category along with an input portion to add records to the given category.

### DETAIL DESCRIPTION

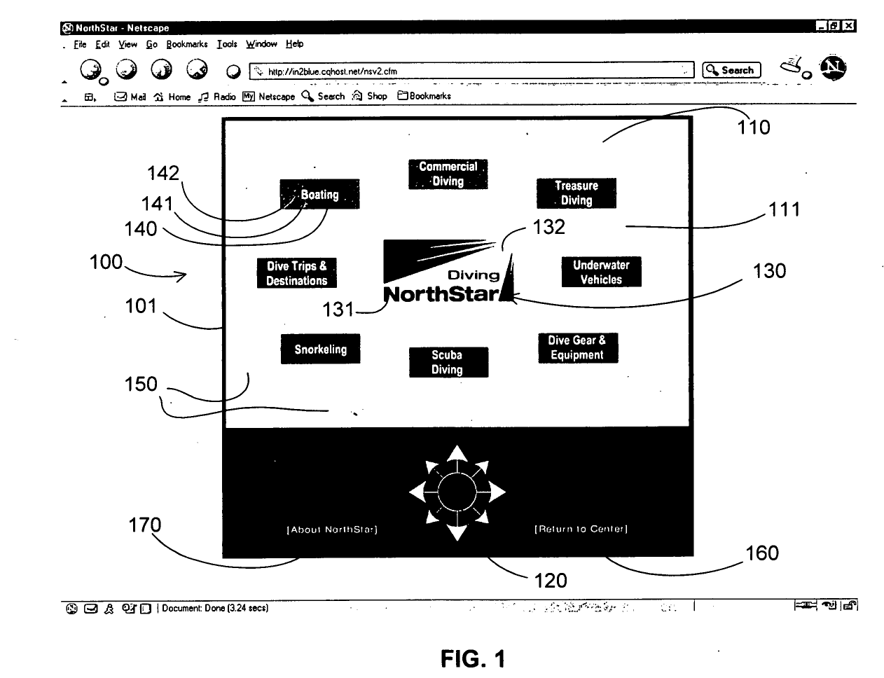

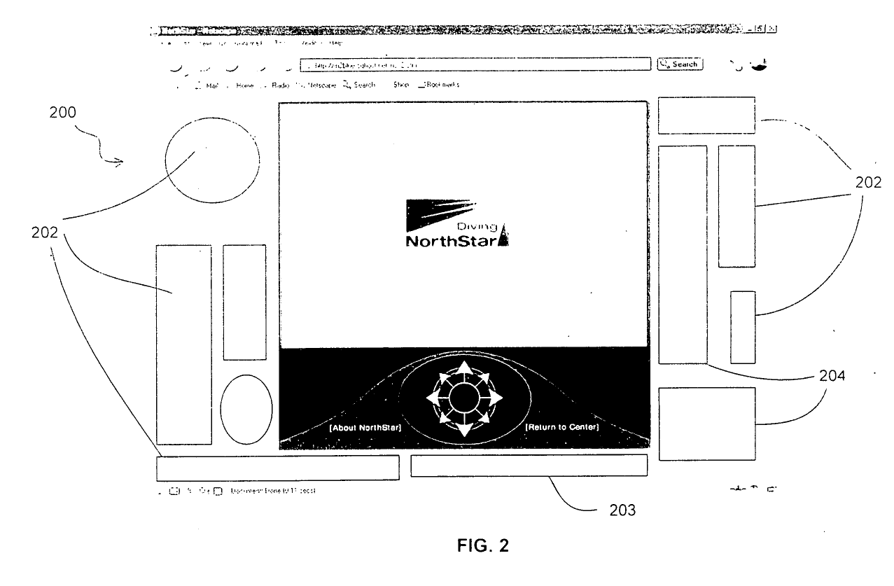

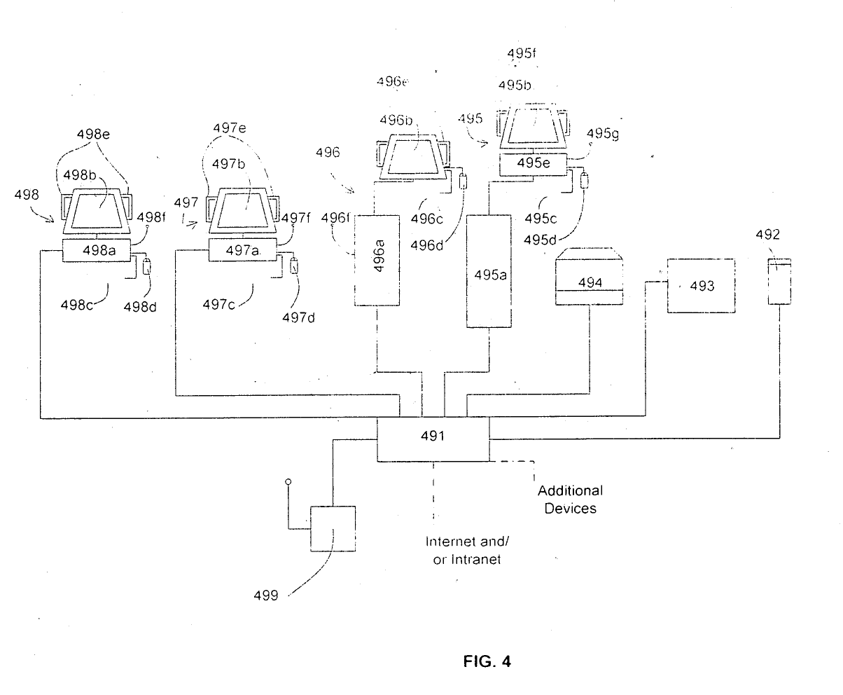

Referring initially to FIGS. 1 and 4, there is shown an embodiment of an EIAS (EIAS) in accordance with the present invention with the subject domain 130 being “Diving NorthStar”. FIG. 2 depicts an alternate EIAS embodiment comprising either at least one advertising banner 202, at least one tool bar 203, at least one menu 204, a sub-combination thereof or a combination thereof at least partially surrounding a viewing window 101. It should be understood that at least one additional tool bar and, or, menu may be provided to, for example, facilitate access to other subject domains and, or, search engines. Any tool bar and, or, menu may be configured with mouse over, clickable or partially mouse over/partially clickable selection functionality. A user input window may be provided to allow alpha and, or, numeric text input; this input window may be configured such that as the text is entered, similar, or recently entered, “strings” appear near, or in, the window for acceptance by the user as known in the art. An EIAS may be configured such that a description of the selected item appears proximate the item to describe the related function and, or, to provide an index of related options. Microsoft's “help” features may be incorporated for example. Additional items that may be incorporated into a tool bar include text and, or, word search functionality and, or, an index of available subject domains. A tool bar and, or, menu may incorporate a “filter” to diminish and, or, narrow the universe of topics represented on a corresponding concept map. For example, if a person is looking at a concept map representing real property for sale, a user might want to limit the universe of topics to vacant land and, or, commercially zoned property or residential properties listed for under $500,000. Other EIAS embodiments incorporate at least one column and, or row, of smaller viewing windows proximate the viewing window 101. As described in detail herein, the smaller viewing window(s) may be configured to cooperate with the viewing window 101 to provide a “three dimensional” perspective. It should be understood that at least one of the smaller viewing windows may display substantially all, or all, of the concept map and may be configured such that when a user selects a particular portion of the concept map in the smaller viewing window that portion is then displayed in the viewing window 101. An EIAS may be configured to comprise a first-person, point-of-view, 3-D “world experience”. A user accesses the 3-D environment by selecting a subject topic or sub-subject topic of the corresponding concept map. Preferably, a side window, or an overlay window, would open that provides a first-person point-of-view in a 3-D enhanced world. For example, a person could explore, via the 8-way navigation, a concept map of a town and select a subject topic or sub-subject topic representing a mall and open a 3-D experience of the mall. The user could explore the mall and “walk into” a shop and see what they are selling or their discounted specials. Navigation of this 3-D enhanced world is preferably configured through using the keys of a corresponding pointing device to control the camera that is providing the first-person point-of-view. The corresponding controls are preferably configured to allow the user to rotate, reverse and forward the camera. In the construction of the 3-D environment, one preferably guards against this virtual reality overwhelming the user. Preferably, the user never gets lost and has the ability to retrace their movements via an appropriate interface. A tracking system may be provided on the visual interface such that the user can put their location in perspective and, or, context. Also, when advertising banners are incorporated in this 3-D world, there preferably is a tracking system that allows an advertiser to know if their advertisement has been “walked by” or selected. The 3-D world may have embedded video, sound, MP3s, message boards, customer service, real-time feedback, and “webcams”. The EIAS, under at least one subject topic and, or, sub-subject topic may establish at least 100 information links and have the ability to make these links visible or invisible. The individual links may be turned on and off like a light switch and become active when it is desired to add an additional link; this feature does not require “cracking open” the FLASH presentation to add a link.

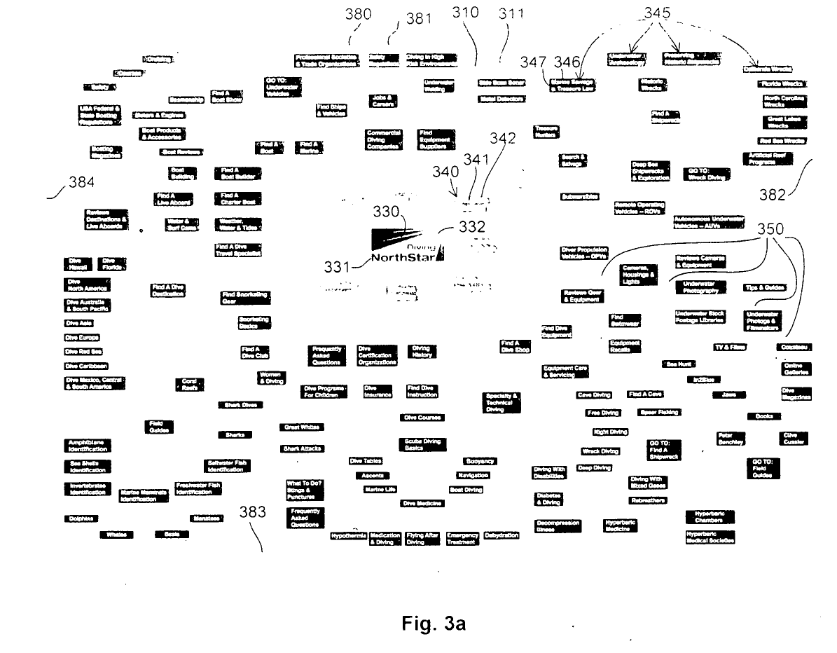

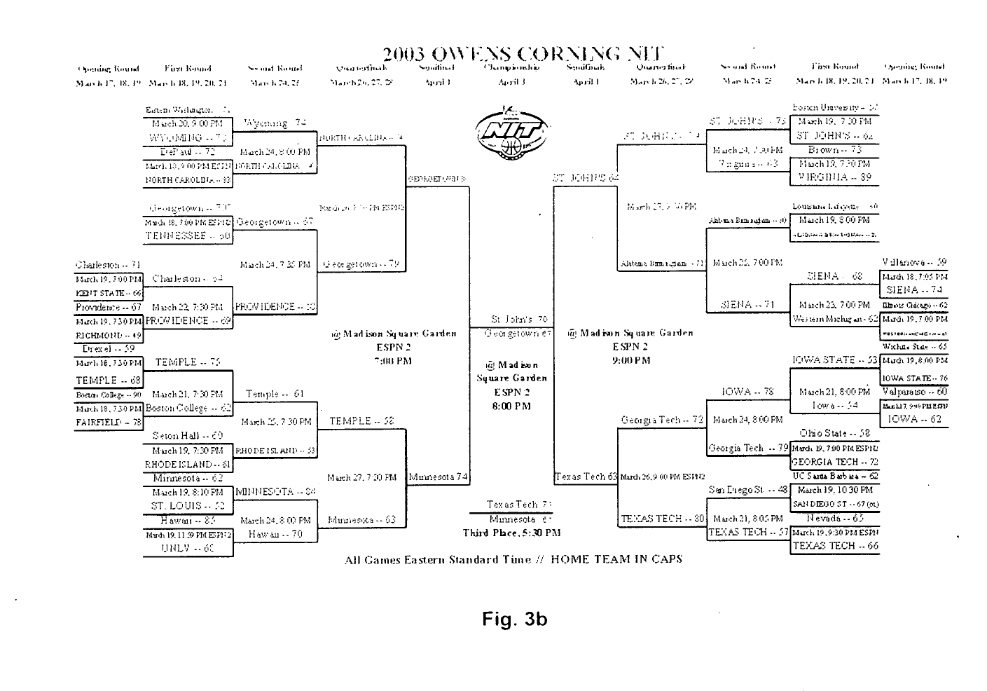

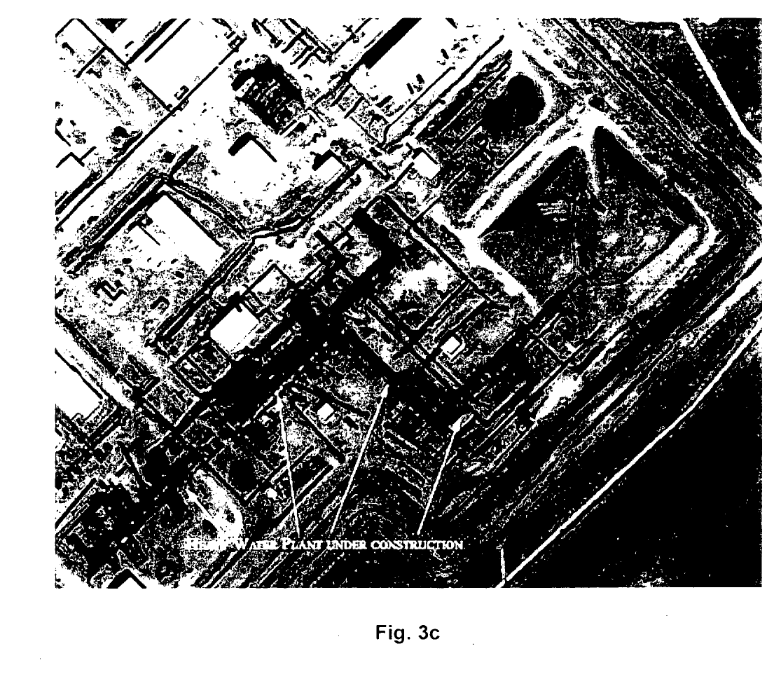

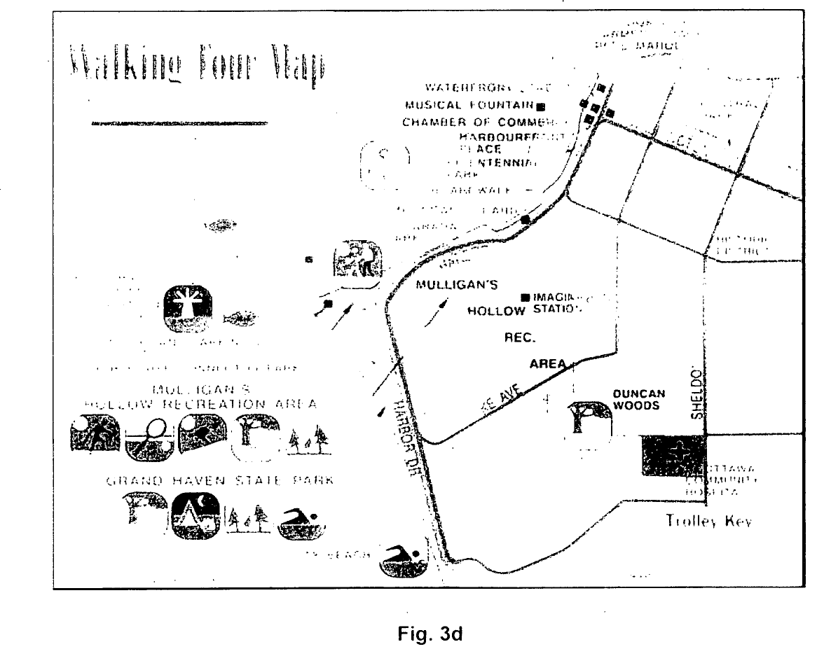

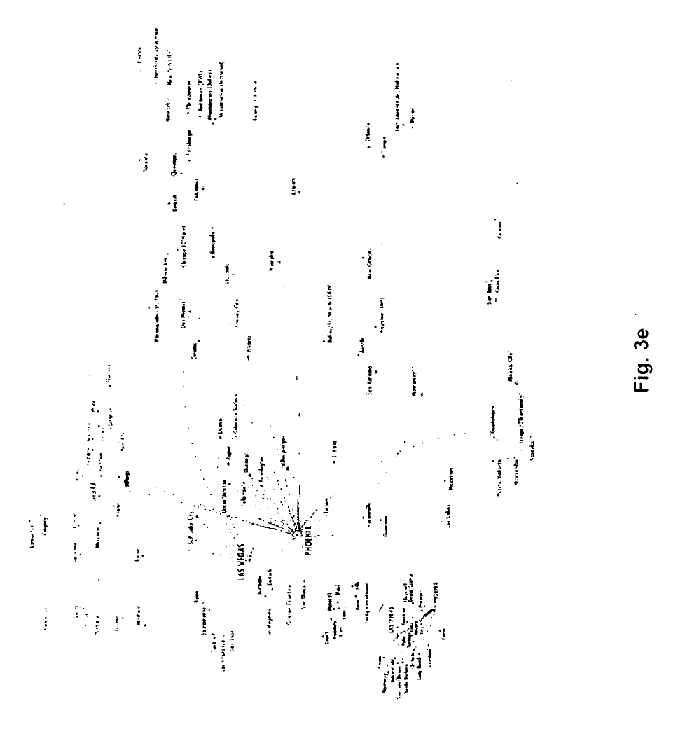

Turning now to FIGS. 3a-3e, various concept maps are depicted for use with the present invention. It should be understood that individual images, graphics, text, photographs, motion pictures, sub-combinations thereof or combinations thereof contained within a given concept map may be configured to function similar to the subject topics and, or, sub-subject topics described herein. For example, selecting one of the buildings of FIG. 3c may result in an electronic information links page being displayed that includes various detail about the building, equipment within the building, operations manuals, parts suppliers, parts availability, drawings, emergency manuals, floor plans, contact information, etc. The EIAS may be configured such that thumbnail size photographs and, or, images are incorporated in a concept map and selection of the thumbnail launches a larger depiction. It should also be understood that concept maps with icons (i.e. links to multi-media electronic information) such as described in U.S. Pat. No. 5,506,937, to Ford et. al, that describes a concept map based multimedia computer system for facilitating user understanding of a domain of knowledge (i.e. patient medical information) may be incorporated, the entire disclosure of this patent is incorporated herein by reference. It should be understood that the concept map may be related to the Diving NorthStar subject domain 130 as shown in many of the Figs. included herein or may be related to any other subject domain such as sports tournament brackets 310b, facilities 310c, road maps 310d, air flight routes 310e, expert systems, decision trees, hiking trail maps, bike paths, high school football, golfing, gardening, skiing, corporate operations, corporate facilities, product catalogs, corporate personnel, personal household records, product sales and marketing, intellectual property portfolios, educational materials, medical information, research projects (such as TRIZ applications), law enforcement efforts, “911” related information, public safety forces information or any other electronic information. For example, a concept map using a pre-established template may be created that sets forth a structure for an investigation, research or project. The related EIAS may be configured such that participants may directly access a related database and, or, enter data, as well as, links to important documents; alternatively, the participants could simply fill out structured reports with tags that would automatically update the database. U.S. Pat. No. 5,956,708, to Dyko et al., discloses an integration of link generation, cross-author user navigation, and reuse identification in authoring process, the entire disclosure of which is incorporated herein by reference. When an EIAS embodies a collaborative effort, it may be configured such that when additional information is added and, or updated, a color, or other characteristic, of the subject topic and, or, sub-subject topic changes to visually indicate that some related information has been modified and, or, indicate who modified it. After a person selects a subject topic or sub-subject topic with the new information, the color or other characteristic may revert to a default. Optionally, or additionally, an index may be incorporated in the EIAS to depict a list of updated items and, or, an mail “alert” may be automatically sent to desired collaborators notifying them of the updates. It should be understood that a central control point may be designated to accept or reject the updates. The central control point may be a person or a filter with parameters and, or, built in controls to manage the updating process.

It should be understood that the concept map may depict a geographic information system (GIS), a tax map, Auditor's records, and other, typically, governmentally maintained information. Rail roads, bus lines, cruise ship lines, subway systems, air travel routes, air travel schedules, shipping schedules and, or, shipping routes may be depicted in at least one concept map. Financial institutions, banks, automatic teller machines (ATMs), insurance companies, credit card companies, or other service oriented operations may be depicted in at least one concept map. Other concept maps may depict utility operations, such as, electric, transmission systems, natural gas, pipelines, water, sewer, telecommunication, cable television, telephone, internet service providers, fiber optic lines, or other highly geographically distributed facilities. Individual customer account information, facilities information, equipment information, flow data, system use data, system status information, etc. may be configured to be accessible via graphics and, or, text within the concept map with similar functionality as the subject topics or sub-subject topics described herein. Related EIASs may be configured such that selecting a related image, graphic, text, photograph, motion picture, sub-combination thereof or combination thereof launches at least one electronic information links page to provide access to items such as license options, reservation options, contract options, purchase options, ticket options, payment options, account information and billing. A related EIAS may comprise “real time” electronic information. Having combinations of the individual listed concept maps superimposed with one another is within the scope of the present invention. In EIASs that comprise real time and, or, frequently updated electronic information, the dynamically configured information links page feature as described herein may be beneficial.

An example of an EIAS, described with reference to FIG. 3e, has airline routes represented with graphic lines extending between associated departure and arrival airports. A related EIAS may be configured such that selecting a given graphic line will result in launch of a user interface with available flight information and, or ticket purchase options. It should be understood that at least one additional tool bar and, or, menu item may be incorporated to “narrow” the search results to specific date ranges, airlines, departure times, arrival times, airplane type, etc. An EIAS may be configured such that selecting either the departure or arrival node will launch a user interface with corresponding reservation and, or, purchase information. It should be understood that the concept map may depict the entire World or multiple concept maps similar to the one shown in FIG. 3e may be incorporated into an EIAS.

As shown in FIG. 4, the EIAS may be configured to run on a stand alone Apple compatible computer 498 that may comprise at least one of a processor and memory 498a, a monitor 498b, a keyboard 498c, a mouse 498d, speakers 498e and, or, a microphone 498f. Alternately, the EIAS may be configured to run on an IBM compatible computer 497 that may comprise at least one of a processor and memory 497a, a monitor 497b, a keyboard 497c, a mouse 497d, speakers 497e and, or, a microphone 497f. The EIAS VISUAL INTERFACE 100 may be configured to run as a background in a Windows folder, or sub-folder, for example. Th EIAS VISUAL INTERFACE may be configured to run as a web page within a web browser (i.e. Netscape is just one of those available as described herein) as shown in the Figs. herein or may be configured to run as a stand alone program. The EIAS may be configured as an operating system component, for example, within a Microsoft operating system, an Apple operating system, Novel, LINEX, UNIX, etc. Alternatively, the EIAS may be configured to be the operating system having periphery control built in.

As additionally shown in FIG. 4, the EIAS may be configured to run on a main frame 496 that may have a processor and memory 496a, a terminal 496b, a keyboard 496c, a mouse 496d, speakers 496e and, or, a microphone 496f. Alternatively, the EIAS may be configured to run on a server/workstation 495 that may have a server 495a, a processor and memory 495e, a monitor 495b, a keyboard 495c, a mouse 495d, speakers 495f and, or, a microphone 495g. The EIAS may be configured to run on a personal digital assistant (PDA) 492, a Palm Pilot or an “OnStar” type device. A printer 494 and, or, a scanner 493 may be incorporated in the EIAS. It is also envisioned that a hub and, or, router 491 may be employed within an EIAS and, for example, have portions of the overall EIAS and, or, underlying electronic information distributed across a local area network (LAN), a wide area network (WAN), an intranet, the internet, or combinations of several of the devices as shown in FIG. 4. The EIAS may incorporate a wireless device 499 to facilitate further interoperability with additional electronic devices. It should be understood that a plurality of any of the devices shown in FIG. 4 may be incorporated in an EIAS along with additional devices, such as, cellular telephones; electronic game players; electronic cameras; video devices; audio devices; pagers; lap top computers; copiers, televisions; storage devices, such as, CDs, DVDs, floppy disks, tapes, MP3s, zip drives, USB compatible memory devices, memory sticks, hard disk drives, hard drives etc. It should be understood that each monitor and, or, printer and an associated keyboard and, or, mouse are configured to function as a visual interface cursor and pointing device. Either at least one monitor, at least one printer or a combination may provide an electronic display. It should be understood that a mouse may comprise a right physical button, a left physical button and, or, a “wheel” type physical actuator. The wheel type physical actuator may be configured to zoom in on the concept map when manipulated in one direction and may zoom out with respect to a second direction. A roller ball and, or, “joy stick” type pointing device may be employed as well. It should be understood that the pointing device may be a wireless configuration as known in the art. It should be understood that the pointing device and, or, monitor may be configured as a “touch” sensitive device such that at least one functional feature of the EIAS may be manipulated with movement of a corresponding human body part and, or, may be voice actuated.

The individual devices depicted in FIG. 4 may comprise a Microsoft NT operating system, Apple operating system, Novel networking system, Linex operating system, UNIX operating system, Cisco, Microsoft Windows operating system, Windows NT, OS2, Apple operating system, Mac OS X, DOS, etc. software for stand alone operation and, or, “networked” operation. It should be understood that one of ordinary skill in the art will recognize that an EIAS of the present invention may be configured to run on a SUN computer, an Apple compatible computer, a DEC computer, an IBM compatible computer or any other similar system.

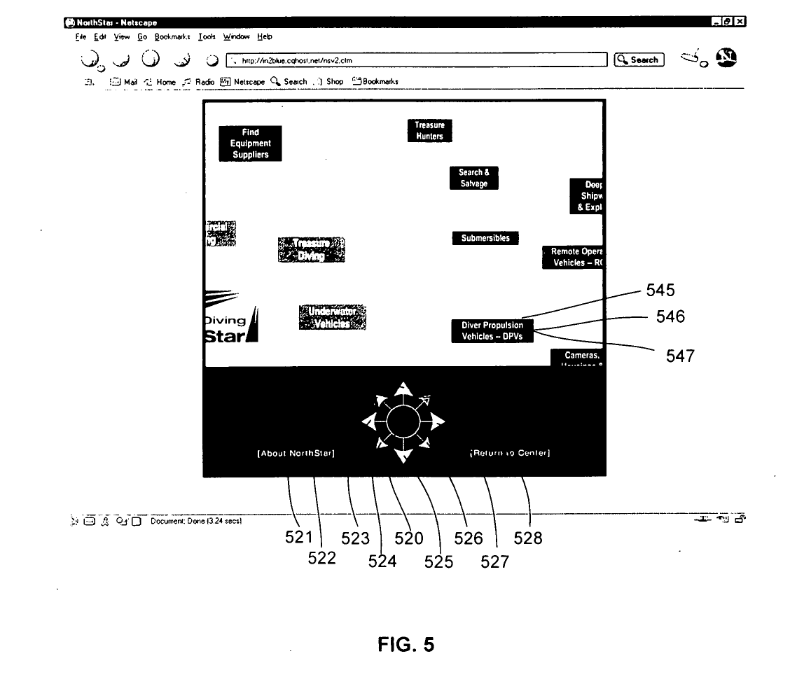

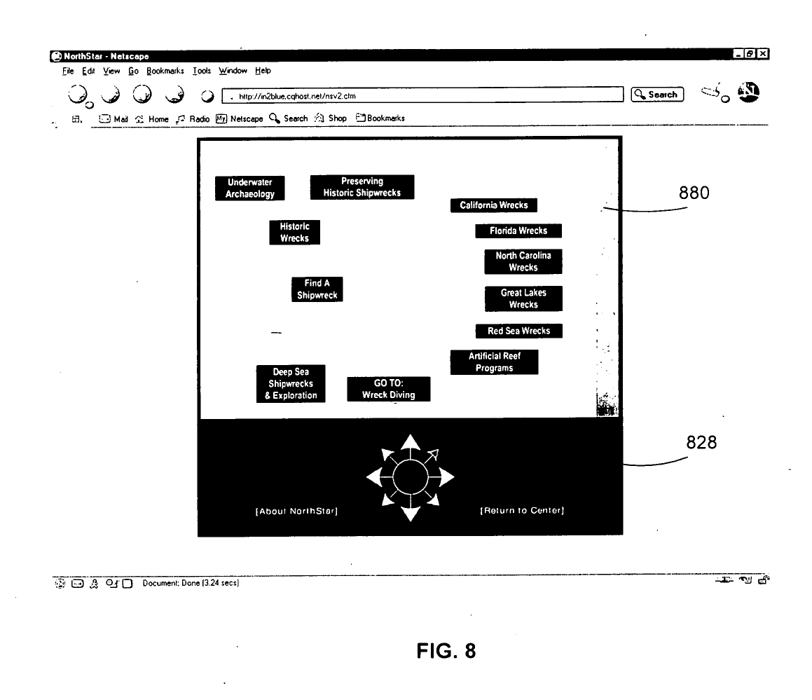

Referring additionally to FIGS. 5 and 8, the EIAS is shown to include a Visual Interface (VI) 100. The EIAS VISUAL INTERFACE is shown to include a concept map 110 positioned to be at least partially visible within a viewing window 101. The EIAS VISUAL INTERFACE preferably imparts an intrinsic order and, or, structure to the underlying electronic information.

Concept maps are known by a variety of names, including, but not limited to: conceptual maps, c-maps, visual maps, visual data maps, space diagrams and mind-maps. In a preferred embodiment, the concept map 110, 310a, 310b, 310c, 310d, 310e is larger than the viewing window 101 such that only a portion of the given concept map is visible at any given time. A navigation interface 120, 520 is preferably provided to enable a user to selectively view a desired portion of the concept map within the viewing window. Details of this and other features of EIASs in accordance with the present invention are described in detail herein. It should be understood that in at least one embodiment, the EIAS VISUAL INTERFACE has at least one concept map depicting a subject domain, a motion picture, sports tournament bracket, at least one facility, road map, at least one solar system, at least one planet, a world map, at least one continent, at least one country, at least one state, at least one municipality, air flight routes, a map, geological maps, sub-division maps, building plans, architectural plans, hiking trails, bike paths, high school football, golfing, gardening, sports, at least one team, at least one athlete, card tournament, information related to at least one person, skiing related information, corporate operations, corporate facilities, a heating system, an air conditioning system, a ventilation system, decision tree, future scenario tree, social network, expert system, a just in time learning system, just in time manufacturing, theory of constraints (TOC) trees, TOC principles, TOC techniques, medical expert system, legal expert system, emergency preparedness plan, at least one creek, at least one mountain, at least one island, a file management system, a note management system, a docketing system, a collaborative effort, a research effort, a TRIZ effort, a mining operation, a garbage company, a grocery company, an agricultural operation, a forestry operation, an employment agency, an office building, a campus, a vehicle manufacturer, vehicle sales company, law firm, an accounting firm, a church, a camping area, a night club, at least one bookstore, a military operation, a satellite system, a mail route, a travel agency, a restaurant company, a shopping mall, a warehouse company, a fitness operation company, a library, a genealogy chart, banquet facility, furniture company, oil company, gasoline retail operation, grain elevator, pet store, vehicle rental company, vehicle repair company, at least one product catalog, corporate personnel, personal household records, product sales and marketing, intellectual property portfolios, a project management system, a calendar of events, plants, vegetables, collaborative system, educational materials, medical information, research projects, geographic information system (GIS), a tax map, Auditor's records, rail roads, bus lines, cruise ship lines, subway systems, air travel, shipping routes, electric utility, transmission system, natural gas, pipeline system, water utility, sewer utility, telecommunication system, a computer system, cable television system, entertainment guide, television viewing guide, news summary, log line, at least one library, at least one museum, at least one art center, at least one sports complex, at least one entertainment facility, telephone system, internet service provider, fiber optic lines, at least on financial institution, at least one banking company, at least one automatic teller machine (ATM), at least one insurance company, at least one credit card company, at least one hotel, at least one resort, at least one park, at least one ocean, at least one sea, at least one lake and at least one river, and the like. It should be understood that as used herein the term “concept map” is inclusive of these optional images, graphics, text and, or, motion pictures. In at least one embodiment, the concept map is configured to be dynamic, in lieu of being hard coded, such that a user can modify the concept map. It should also be understood that an EIAS may be configured to be viewed in a “full screen” mode, wherein, the viewing window is substantially all, or all, of the screen (i.e. no advertising banner(s) and, or, tool bar(s), menu(es) surrounding the viewing window). The full screen mode may be the default or may be user selectable using a menu selection, for example, and the escape key, for example, to return to having a less than full screen viewing window.

Alternate EIAS embodiments have individual concept maps that fit within an associated viewing window in their entireties, requiring the user to “drill down” through the various interrelated concept maps to the desired subject topics and sub-subject topics. It should be understood that the viewing window may be larger than the associated display screen, in such event the slide bar and, or, direction arrow functionality often incorporated in browser technology may be employed to view various portions of the viewing window 101. Drill down requires more steps on the part of the user to move around within the concept map. The drill down approach may result in having multiple “windows” open at a given time. When drill down is employed, the user has a narrow perspective of the overall concept map without the underlying interconnecting associations and, or, relationships. The context in which the subject domain is preferably viewed is lost. This increases difficulty in exploring the concept map and, or, complicates discovering desired information.

In preferred EIASs of the present invention, because the concept map is on one level, the associations and, or, relationships are maintained. Having a large concept map on one level, as described in detail herein, increases the EIAS development complexity. However, not having to drill down through multiple concept map levels enhances information access, exploration and, or, discovery.

Preferably, the EIAS concept map 110 sets forth an intrinsic order for a specific subject domain 130 and, or, provides structure to access the otherwise unstructured information. The subject topics 140, 340 and sub-subject topics 345, 545 within the subject domain are preferably set forth with corresponding topic links 150, 350 to convey relationships and, or, associations. These relationships and, or, associations improve a user's acquisition of knowledge and develope a user's expertise in a particular subject. In at least one EIAS embodiment, there are at least three preferred principles behind the development of the concept map (a) the concept map is preferably focused on a narrow subject domain, (b) the concept map preferably has significant depth and breadth, typically not less than 80 subject topics and, or, sub-subject topics. (The Diving NorthStar example shown in the associated Figs., specifically FIG. 3a, has approximately 150 subject topics and sub-subject topics combined) and (c) the concept map is preferably on one level and does not require drilling down. It should be understood that in alternate embodiments, the EIAS may employ only one of the above principles, may encompass various combinations of the above principles and, or, may incorporate additional principles.

An inventive concept with respect to the concept map and associated viewing window of the present invention is restricting the user's view of the concept map to approximately 15 subject topics and, or, sub-subject topics. Without the viewing window, people tend to be besieged by the depth of a large concept map and frequently described it as “overwhelming.” Research shows that most people start experiencing difficulty in assimilating concepts/elements when the number exceeds seven +/−2. It should be understood that a “zoom in/out” feature may be incorporated to allow a user to view a desired number of subject topics and, or, sub-subject topics within the viewing window. Additionally, it should be understood that the EIAS VISUAL INTERFACE may be configured such that more than 15 subject topics and, or, sub-subject topics may be viewed.

Preferably, EIASs of the present invention provide solutions to the problem of accessing unstructured electronic information on the internet, intranets, local area networks and individual workstations, as well as, other distributed electronic information storage and retention devices. Preferably, the unstructured data is rendered accessible by (1) providing an intrinsic order within at least one subject domain and (2) for each subject topic and, or, sub-subject topic set forth in the intrinsic order, providing the best information links to underlying electronic information resources and, or, relevant data relating to the given topic.

Preferably, the EIAS subject topics 140, 340 and sub-subject topics 345, 545 are linked to one another only by a topic link 150, 350 graphical line (i.e. without any linking words as employed in alternative embodiments of th present invention). There are several reasons why it is preferable not to use linking words: (1) the linking words often create a cluttered environment for the concept map; (2) it is desirable to make the connection intuitive, not expressly stated; and (3) when use of the linking words was tested, feedback was negative and most people thought the linking words were not necessary to convey the implicit linkage. It should be understood that alternate EIAS embodiments in accordance with the present invention employ linking words in lieu of, or in addition to, graphical lines.

In at least one embodiment, the EIAS is based, at least in part, upon the concept that, “a key to learning is understanding interconnecting relationships and, or, associations.” The nature of learning is often serendipitous, a person explores and discovers knowledge. Preferably, the concept map and navigation interface are configured to facilitate information exploration and, or, discovery.

In at least one embodiment, an EIAS is created with “web safe” colors for the: subject domain 130, 330, 131, 331, 132, 332; the concept map background 111; concept map border 380, 880; subject topic and sub-subject topic text 141, 341, 346, 546, background 142, 342, 347, 547 and border 1044; topic links 150; navigation interface 120; GO TO button 990, about button 170; return to center button 160 and related graphics of the visual interface 100. It is preferred to have the EIAS VISUAL INTERFACE look substantially, or identically, the same on substantially all monitors and, or, printers utilizing common operating systems and browsers as known and, or, commonly used in the art, such as, Microsoft, DOS, Windows, Apple, Mac OS X, Linex, UNIX, SUN, Netscape, IBM compatible, as well as others listed herein. Preferably, the concept map background 111 is close to white in color; the subject topics 140, 340 have text 141, 341 close to white in color with backgrounds 142, 342 close to light blue in color; the subject domain 130, 330 encompasses areas that range from close to dark blue 131, 331 to close to white 132, 332 in color; the topic links 150 are close to grey in color; the text 346, 546 of the sub-subject topics 345, 545 is close to white in color; the backgrounds 347, 547 of the sub-subject topics 345, 545 are dark blue unless selected”, at which time the background changes close to light blue in color; the subject topic and sub-subject topic borders 1044 are at least substantially invisible until such time that a related “GO TO” button (as described in detail herein) is selected, at which time the border 1044 is, at least momentarily, close to red in color before fading to be substantially invisible. In at least one embodiment, the border fades to close to grey in color at least momentarily subsequent to fading close to red in color before fading to be substantially invisible; the concept map border 880 is close to gold in color; the GO TO buttons have text close to white in color and a background that is close to dark blue in color until selected then close to light blue in color; the individual buttons 521-528 of the navigation interface 520, the about button 170, 1270 and the return to center button 160, 1160 are close to white in color until selected, at which time the given button is close to gold in color and remaining areas of the EIAS VISUAL INTERFACE are within a corresponding range of colors between close to white to close to dark blue. It should be understood that other colors may be selected that accommodate specific desires for any portion of the visual interface. The EIAS may be configured such that any given color is user selectable.

A related embodiment of an EIAS VISUAL INTERFACE has the corresponding text 141, 341, 346, 546 font and, or, size based upon related research conducted by major publishing organizations to improve readability. Optionally, the font and, or, size selection for an EIAS may be based upon the fonts and sizes utilized by entities such as Google, the internet generally, the Washington Post, the USA Today, as well as, others. Preferably, an Arial font is used. Arial, unlike many other fonts, can be viewed without variation on most computers. It should be understood that other fonts and, or, size may be selected that accommodate specific desires for any portion of the visual interface. The EIAS may be configured such that any given font and, or, size is user selectable.

Preferably, “selection” of a desired navigation interface button 521-528 is configured to happen in accordance with “mouse over” selection functionality. Mouse over selection functionality is distinguished from “clickable” selection functionality in that a visual change occurs on a related display and, or, selection occurs simply by moving a cursor associated with a pointing device over the desired button with mouse over selection functionality; clickable selection functionality requires the additional step of manually manipulating a physical button and, or, actuator on an associated pointing device. Preferably, the sub-subject topics 345, 545, the GO TO buttons 990, the about button 170, 1270 and the return to center button 160, 1160 are configured with partially mouse over and partially clickable selection functionality (i.e. the background color changes when an associated cursor is placed over the given button, however, the actual function of the button does not become activated until a physical button and, or, actuator is manipulated on an associated pointing device. The pointing device may be associated with a keyboard, a mouse or both, as well as, any other “pointing device” known in the art such as a touch screen, or the like. It should be understood that the navigation interface may comprise fewer, or more, than eight navigation directions. It should be understood that the navigation interface may be configured to provide multiple dimension navigation; for example, a third dimension may be added for zoom in/out. An alternate third dimension, or added as a fourth dimension, may be a three dimensional concept map or multiple “layered” concept maps. It should be understood that a navigation interface may be configured to rotate a 3D concept map about at least one axis; the navigation interface may be configured to allow rotation about two, three, or more axis, such as a full 360 degree viewing option. It should additionally be understood that multiple navigation interfaces may be provided in an EIAS to facilitate desired functionality. It should be understood that the EIAS may be configured either to have the concept map move within the viewing window or with the viewing window moving around a stationary concept map.

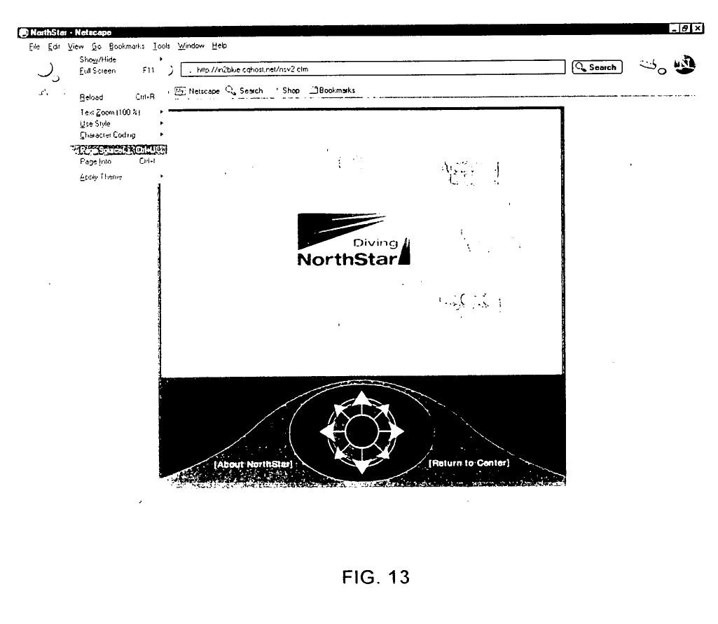

One of ordinary skill in the art will recognize from the discussions contained herein that there are endless applications for the mouse over, clickable and the partially mouse over/partially clickable selection functionality. For example, the navigation interface may be configured such that a cursor of an associated pointing device is positioned at a designated point within the viewing window and the concept map will move in a predetermined direction. For example, positioning the cursor in the upper-right hand corner area of the concept map may result in “NE” (“up/right”) movement. It should be understood that in lieu of, or in addition to, a selected item changing color, the size and, or, shape of the particular item may change when “mouse over” occurs. Additionally, it should be understood that in lieu of, or in addition to, a selected item changing, the cursor may change in size, color, shape or any combination thereof; for example, the cursor may change from an arrow to a hand/finger pointing. This functionality may be configured to be user selectable. Voice recognition activation may also be employed for selection of various EIAS functions. The mouse over functionality may result in a pull down menu item being displayed in an “expanded” view such as that shown in FIG. 13; the desired item on the menu may then be selected via nay of the selection methods described herein.

In at least one embodiment of an EIAS, the associated load time is minimized. When configured as in some alternative embodiments, the size of some of the associated files are, by any standards, huge and may take several minutes to load on a dial-up connection and approximately 10 to approximately 30 seconds on a DSL, broad band or T1 connection. The EIAS preferably uses a process that can render huge amounts of data in minimal download time (several seconds on a dial-up connection, depending on the size of the files, a second or two). Preferably, FLASH MX, available from Macromedia Inc., is used to create at least a portion of the EIAS. FLASH MX facilitates the ability to load an almost unlimited quantity of data at even slow communication speeds, thereby, EIAS load time is minimized. At least partially vector based graphics and, or, use of at least one FLASH MX “symbol” may be employed to accelerate associated loading.

The FLASH action script code, described in detail herein, may be configured to be “hard coded” (i.e. non-dynamic). The term hard coded is used herein to describe an EIAS configuration where each subject topic and, or, sub-subject topic has a uniquely created, non-database dependent, information links page 709. This configuration requires each information links page to be maintained individually. With more than 150 individual combinations of subject topics and, or, sub-subject topics envisioned in some EIAS embodiments, individual information links page maintenance is time intensive, inefficient and costly.

Preferably, the EIAS is configured such that when a user positions a cursor over a particular subject topic or sub-subject topic and clicks an information links page is launched that is generated from a database which stores information links and, or, data. It should be understood that mouse over selection functionality may be employed with one or more subject topic and, or, sub-subject topic. It should be understood that at least one subject topic and, or, at least one sub-subject topic may be at least partially configured as a graphic, an image or text representation of an item selected from the group comprising: text with a background, an item within a motion picture, a person within a motion picture, a site within a motion picture, a product placement within a motion picture, a prop featured in a motion picture, clothing, an event, a plant, a vegetable, a medical symptom, an assumption, a problem, a solution, a building, a piece of equipment, a country, a state, a county, a municipality, a person, an animal, a road, a street, an alley, a highway, a route, a trail, a path, a creek, a mountain, an island, a file, a note, a grocery store, a field, a barn, a green house, a lawyer, an accountant, a broker, a consultant, a contractor, an engineer, a doctor, an architect, a hospital, a radio station, a university, a college, a school, a factory, a farm, a ranch, a field, a team, a football team, a basketball team, a baseball team, a soccer team, a track and field team, a television station, a radio station, a museum, a garden, a park, an ocean, a lake, an airplane, a boat, a train, a ship, a cruise ship, an airport, a line, a port, a house, a record, a musician, an artist, an actor, an actress, an athlete, a patent, a patent application, a book, a magazine, a patient, a thesis, a dissertation, a computer, a telephone, a pager, a pump station, a tank, a compressor station, a generating facility, a well head, a drilling platform, a substation, a transmission line, a pipeline, a pipe, a wire, a fiber optic line, a coaxial cable, a radio frequency link, a transmitter, a receiver, an arena, a stadium, a national forest, GPS coordinates, research leads, investigative leads, a gas station, a club, an association, a convenience store, a hotel, a hotel room, a restaurant, a restaurant menu, a retail store, a mall, a warehouse, a sewer treatment plant, an office building, a water treatment plant, a newspaper, a pet, a car, a truck, a piece of real property, a marina, an audio recording, a video recording, an appliance, an aquarium, a motion picture, a bank, an ATM, an account, a customer, and an address.

Preferably, a database is utilized to facilitate creation of dynamic information links pages that may be substantially instantaneously updated and substantially continually improved. Combining FLASH MX with a database for purposes of accessing, and, or searching electronic information is preferably accomplished using COLDFUSION, available from Macromedia, Inc., as described in detail herein. Preferably, Microsoft SQL server software, available from Microsoft Corporation, is used to create and maintain the associated database. It should be understood that other “linking” software, such as JAVA, JavaScript, HTML, XHTML, XML, CSS, ECMAScript, the DOM, KHTML, C, C+, C++, visual C, visual C+, visual C++, visual basic, etc., may be used in lieu of COLDFUSION and other database software such as ORACLE, QuattroPro, Lotus, Access, etc. may be used in lieu of SQL server. It should be understood that dynamic information links pages are advantageous irrespective of the number of actual subject topics and, or, sub-subject topics. It should be understood that, irrespective of being hard coded or dynamic, the information links pages may be configured to launched in another “window” such that the user “exits” the page to return, or may be launched within the same window such that the user uses a “back” function to return. Alternatively, a back and, or, a forward button may be incorporated within the EIAS VISUAL INTERFACE in combination with items being launched within a common window. An EIAS may be configured such that the information links appear proximate to the viewing window; a scrolling feature may be incorporated to allow a user to selectively view at least one information link from a plurality of information links. It should be understood that more than one information links page may be associated with any given subject topic and, or, sub-subject topic; an interface may be provided to allow a user to selectively view a desired page or pages. An interface may be provided to allow a user the ability to selectively organize the display of individual information links and, or electronic data, such as, by chronological order, by author, by relevancy, by most recently accessed, etc. An EIAS may be configured such that the individual information links and, or, electronic data is automatically displayed by chronological order, by author, by relevancy, by most recently accessed, etc.

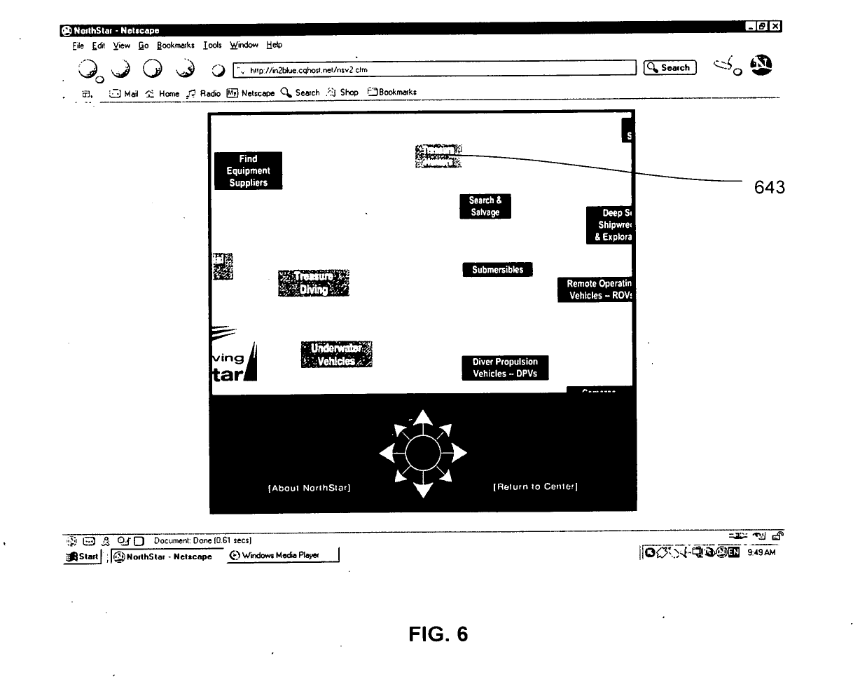

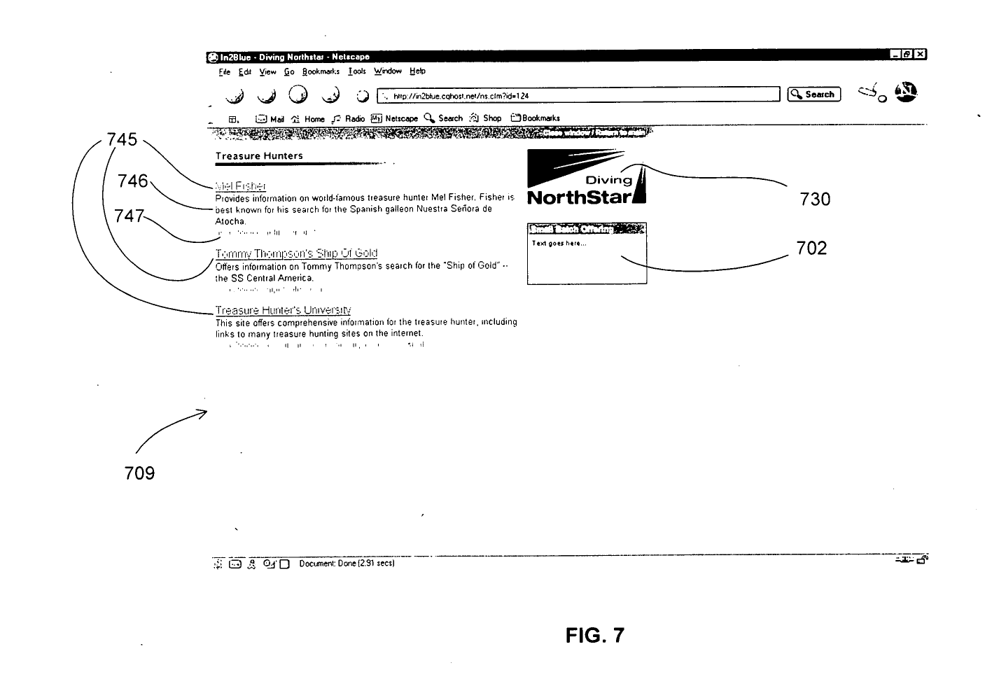

Referring now to FIGS. 6 and 7, preferably the EIAS is configured such that when a user positions an associated cursor over and clicks on a subject topic or sub-subject topic an information links page is launched having the best pre-screened electronic information links 745 available. Preferably, substantial time and, or, effort are devoted for screening sources of electronic information to assure that the best and most credible electronic information links for that subject topic or sub-subject topic are presented to an EIAS user. In at least one EIAS embodiment, a subject matter expert is employed to prescreen the electronic information links. It should be understood that mouse over selection functionality may be employed with at least one subject topic and, or, at least one sub-subject topic. In at least one related EIAS embodiment, information links pages are provided with data; collaborative data, such as research observations, investigative leads or tips; information links; or any combination thereof. It should be understood that the information links page may comprise in lieu of, or in addition to, an information link, at least one of: a data entry template, an audio recording, a motion picture, an image, and a graphic. It should be understood that at least one tool bar and, or, at least one menu may be incorporated into the electronic information links page of FIG. 7.

Results from keyword and text based search engines are often times subject to external manipulation. Many of the keyword and text based search engines accept payment for placement and, or, for “front of the line” privileges. At least one of the EIAS commercial approaches of the present invention avoids these, and many other, problems associate with known keyword and, or, text based search engines. It should be understood, however, that known search engine techniques may be incorporated in an EIAS, for example, to access a desired subject domain.

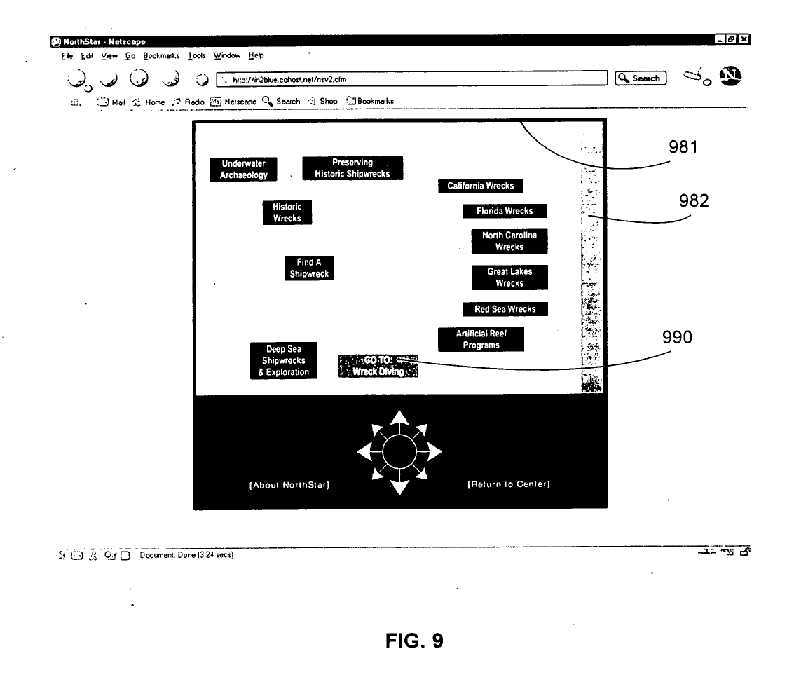

Turning now to FIGS. 8 and 9, there is shown a concept map having a border 880 for indicating to the user that an edge of the concept map has been encountered. As shown, the upper and right sides of the concept map have been reached as a result of selecting the “NE” navigation interface button 528. It should be understood that the upper border 981 may be a different width than the right side border 982 and, or, each side 382, 384, upper border 381 or lower border 383 may have unique widths. Preferably, the border 380, 880 is close to gold in color and is approximately 0.5 inch wide or less. In should be understood that in lieu of, or in addition to, a border a concept map having a distinct background may be configured to allow an area outside the concept map to be a different color and, or, a concept map incorporating at least one graphic and, or, image may be incorporated with no border.

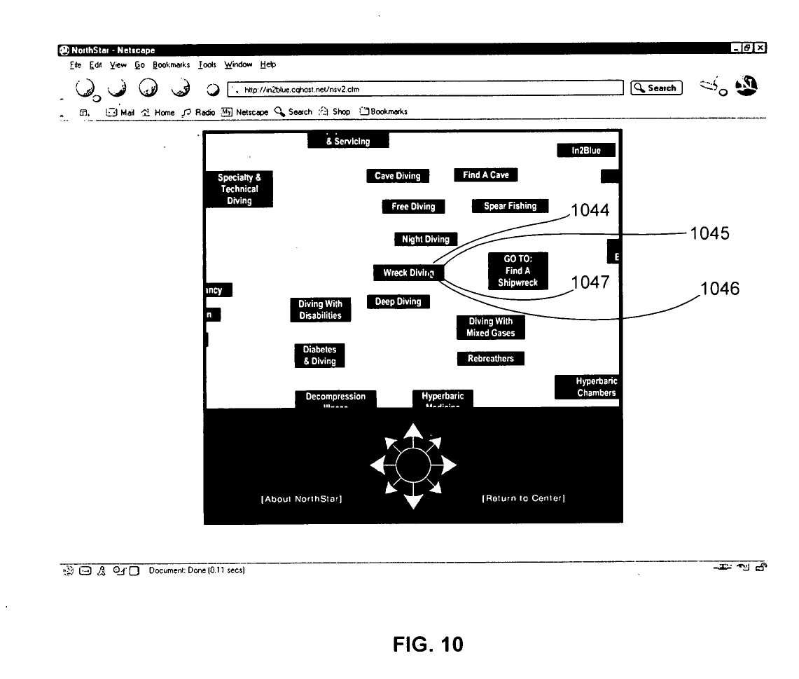

Turning now to FIGS. 9 and 10, because the concept map is often times very large and is preferably on one level, significant difficulty arises in setting forth all desired associations and relationships between the various subject topics and, or, sub-subject topics. In the subject domain Diving NorthStar, for example, under the general subject of “Scuba Diving,” the sub-subject topic “Wreck Diving” is located. However, in another part of the concept map, under the subject topic “Treasure Hunting” the sub-subject topic “Find A Shipwreck” is located. Irrespective of how the subject topics and, or, sub-subject topics on the concept map are manipulated, bringing the sub-subject topics “Wreck Diving” and “Find A Shipwreck” into close proximity to establish an association is not possible without disturbing numerous other subject topics and, or, sub-subject topics and their respective relationships. In order to resolve this dilemma and several others like it, a “GO TO” button is preferably employed as described in detail herein. For example, a button titled “GO TO: Find A Shipwreck.” is preferably associated with “Wreck Diving”. This button is preferably configured such that when a user positions a cursor over this button and dicks (i.e. preferably, the background changes and, or, the cursor changes as described herein), they preferably will be “transported” to the area of the concept map with the “Find A Shipwreck” sub-subject topic substantially centered with respect to the viewing window.

When this GO TO feature was tested, it was well received, however, sometimes the users had difficulty quickly seeing the associated subject topic or sub-subject topic. This problem is preferably resolved by having a noticeable, but preferably not overwhelming and most preferably a subtle red border 1046 of the “Find A Shipwreck” sub-subject topic 1045 (or subject topic) appear for a period of time, preferably for several seconds, and then fades away entirely. Optionally, the border may intermediately appear grey momentarily before fading away entirely. Creating a concept map on one level will often benefit by incorporation of at least one GO TO button. It should be understood that mouse over selection functionality may be employed with the GO TO button.

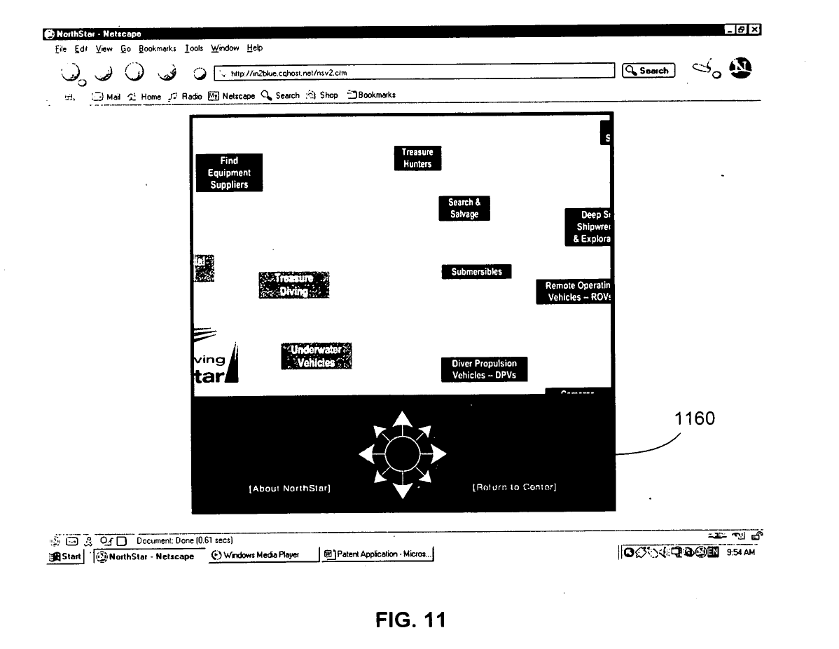

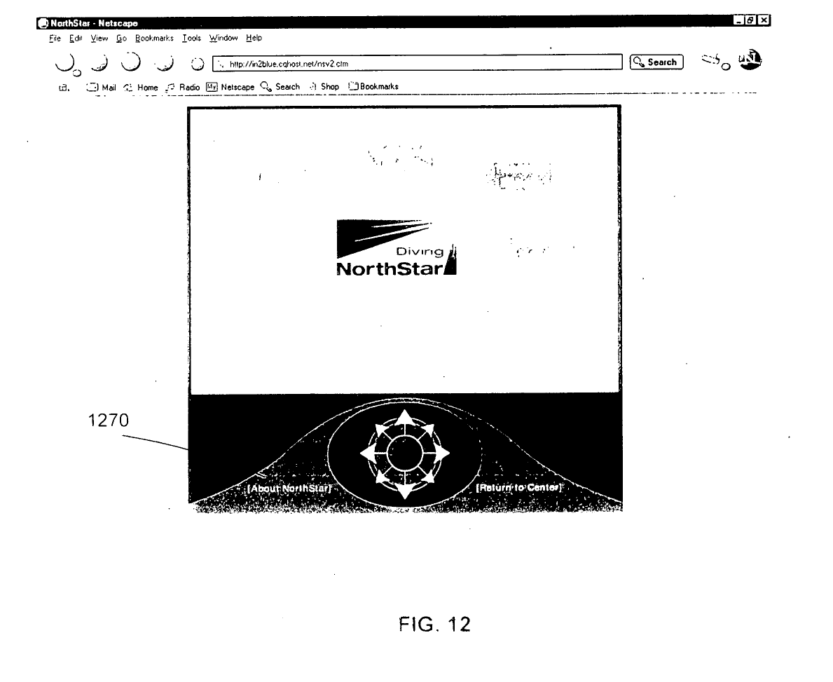

Referring to FIGS. 11 and 12, to accommodate situations when a user has positioned the concept map away from the default position and desires to return to the default portion of the concept map, the EIAS is preferably configured such that a user needs only position an associated cursor over the “Return To Center” button 1160, depicted as [Return to Center] in FIG. 11, and click (i.e. preferably, the text changes and, or, the cursor changes as described herein). The user will preferably be “transported” to the default position of the concept map as shown in FIG. 12, for example. Otherwise, the user may have difficulty locating the default position of particularly large concept maps. In at least one EIAS embodiment, the default concept map position depicts the most broad and, or, general topics; as one moves further from the default position, the topics become more and more narrow and, or, specific. It should be understood that mouse over selection functionality may be employed with the return to center button.

With further reference to FIG. 12, an “About” button 1270 is depicted as “[About NorthStar]”. Preferably, at least one about button is included in the EIAS to provide the user with at least one of the following: 1) general information about the EIAS, 2) help regarding the EIAS, 3) information on how to suggest a source for electronic information (i.e. a “site” or “information link”), 4) information on how to link the EIAS to another's site or page, 5) information on reporting EIAS errors and problems, 6) information regarding submittal of EIAS comments and suggestions, 7) information on associated business opportunities, 8) an overview of the EIAS, 8) information regarding the strategy behind the EIAS, 9) terms and conditions associated with the use of the EIAS.

The EIAS is preferably configured such that a user needs only position an associated cursor over the “About” button 1160 and dick (i.e. preferably, the text changes and, or, the cursor changes as described herein) and a related about page will be presented. It should be understood that mouse over selection functionality may be employed with the about button. Additionally, it should be understood that any of the items listed above for inclusion under the about button related information may have a separate and, or, independent button added to the EIAS VI. The about page may be launched in its own “window” or may be launched such that it is the visible page in the then current window.

Following are some examples of information that may be presented in response to selection of a corresponding button. It should be understood that all of, or any part of, the information presented in the following examples may be incorporated into various embodiments of an EIAS in accordance with the present invention. In some embodiments, additional information is incorporated. Where the term “Diving NorthStar” or word “NorthStar” are used, it should be understood that EIAS may be inserted to render the text of the specific example applicable to any EIAS of the present invention. Where the term “topic” is used herein, it should be understood that subject topic and, or, sub-subject topic may be inserted to render the text of the specific example applicable to any EIAS of the present invention. Additionally, it should be understood that the term “visual map” as used in these examples may be replaced with concept map to more generally described the given example.

Example “About NorthStar”

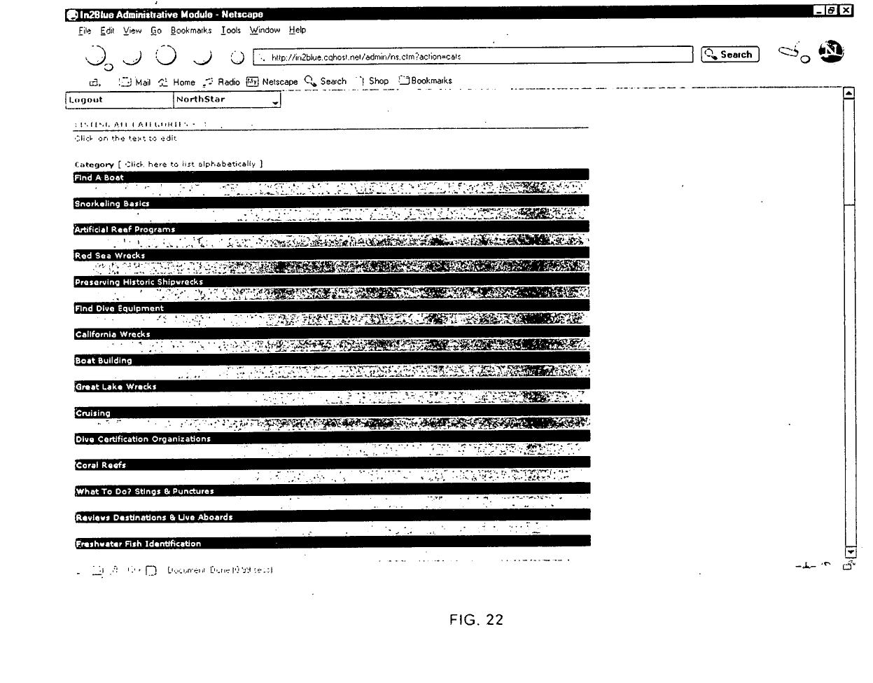

The NorthStar provides a visual map setting forth an intrinsic order for topics within a subject domain. Our visual map organizes concepts and ideas, and captures underlining relationships and associations, so that they have meaning and can be understood intuitively. If you click on a topic, you will get links to the best online resources that we can find for that subject. We do not accept payment for placement of a link nor for front of the line positions. If you would like to learn more about NorthStar, please click here: (a screen similar to that shown in FIG. 22, modified with entries for entry of the inquirer's contact information and, or, a separate web page or site, a name, telephone number, email address and, or, address may be provided here).

Example “Help Page”

If you have questions about how to use the NorthStar, please visit: (a separate web page or site, a name, telephone number, email address and, or, address may be provided here).

You can navigate the NorthStar concept map by placing the mouse on any arrow of the 8-way navigation interface. The arrow you choose, will determine the direction you move. If you want to stop, just move the mouse from the arrow.

Move the mouse over a topic on the concept map and it will change colors. Click on a topic and it will launch a new browser window with links to the best online resources that we can find for that subject. Click on a link and you will go directly to the online resource. If you want to return to the NorthStar link page, simply click on the browser back button.

Click on “Return To Center,” if you desire to reset the visual map to its initial default position.

Example “Suggesting A Site”

Our goal is to provide only the best links to online resources. Please let us know of any web site that we should consider for listing under a topic, by clicking here: (a screen similar to that shown in FIG. 22 may be inserted here).

Step 1: Check to see if your site is already listed under a topic within the Diving NorthStar.

Step 2: If your site is not listed, please find the most appropriate Diving NorthStar topic for your site.

Step 3. Once you've found the most appropriate topic for your site, you are ready to suggest it. Just click on the “Suggest a Site” link below. You will see an online form asking for information about your site. Please be prepared to provide, among other information, your site's title, universal resource locator (URL), and a brief description, as well as, the appropriate topic for your site. Thanks for suggesting a site. To “Suggest A Site,” please click here: (a screen similar to that shown in FIG. 22, modified to facilitate the desired submittal, may be inserted here and, or, a separate web page or site, a name, telephone number, email address and, or, address may be provided here).

Example “Link To”

If you would like to place the Diving NorthStar icon on your web site and link to us, it's free, quick and simple; just click here: (A screen similar to that shown in FIG. 22, modified to facilitate the desired link, may be inserted here. Optionally, the link can be configured to automatically occur upon selection of a related tool bar and, or, menu.)

Link your web site to the Diving NorthStar and provide your visitors with access to the best online resources for the subject domain of scuba diving. By using our graphics to link to the Diving NorthStar, you are agreeing to these Terms and Conditions. (a screen similar to that shown in FIG. 22, modified to facilitate the desired submittal, may be inserted here and, or, a separate web page or site, a name, Telephone number, email address and, or, address may be provided here).

Example “Terms and Conditions”

As used in this Agreement, “we” means Diving NorthStar, and “you” means the natural person and/or entity who seeks to link to the Diving NorthStar. “Site” means a World Wide Web site and, depending on the context, refers either to Diving NorthStar's site, located at the URL www.______, or to any site that you will link to our site. You may only use our logos, graphics and text (singularly and collectively “NorthStar Graphics”) and code found on the Link To NorthStar pages. By using the NorthStar graphics and code, you agree to be bound by the following terms and conditions:

1. We grant you a nonexclusive, revocable right to use the NorthStar Graphics for which we grant express permission, solely for the purpose of placement on your web site and for use by the users of your site. You may not modify the NorthStar Graphics (including the html code), or any other of our images, in any way. We reserve all of our rights in the NorthStar Graphics, any other images, our trade names and trademarks, and all other intellectual property rights. We may revoke your license at any time by giving you written notice.

2. You may not display the NorthStar Graphics in any manner that implies a relationship or affiliation with, sponsorship, or endorsement by NorthStar, or that can be reasonably interpreted to suggest editorial content has been authored by, or represents the views or opinions of the NorthStar. The NorthStar should not be the most prominent element on your web page.

3. The NorthStar Graphics must appear by itself, with a minimum spacing of 25 pixels between each side of the Logo and other graphic or textual elements on your web page.

4. You may not display the NorthStar Graphics in a manner that is misleading, defamatory, infringing, libelous, disparaging, obscene or otherwise objectionable to us, or impairing of the rights of NorthStar in its trademarks or logos, in NorthStar's sole uncontrolled opinion.

5. You may not use the NorthStar Graphics on a site that:
violates any law or regulation* promotes sexually explicit materials
promotes violence
promotes discrimination based on race, sex, religion, nationality, disability, sexual orientation, or age
promotes illegal activities
otherwise violates intellectual property rights.

6. You may not frame or mirror any NorthStar page (including the page that appears in response to a click on the NorthStar Graphics) on your web page.

7. We reserve the right in our sole discretion to terminate your permission to display the NorthStar Graphics at any time and to take action against any use that does not conform to these terms and conditions, infringes any of our intellectual property or other right, or violates applicable law.

8. Either you or we may terminate this Agreement at any time, with or without cause, by giving the other party written notice of termination. Upon the termination of this Agreement for any reason, you will immediately cease use of, and remove from your site, all links to our site, and all trademarks, trade dress, and logos, and all other materials provided by or on behalf of us to you pursuant hereto or in connection with our link program.

9. We may modify any of the terms and conditions contained in this Agreement, at any time and in our sole discretion, by posting a change notice or a new agreement on our site. IF ANY MODIFICATION IS UNACCEPTABLE TO YOU, YOUR ONLY RECOURSE IS TO TERMINATE THIS AGREEMENT. YOUR CONTINUED DISPLAYING THE NORTHSTAR GRAPHICS, FOLLOWING OUR POSTING OF A CHANGE NOTICE OR NEW AGREEMENT ON OUR SITE WILL CONSTITUTE BINDING ACCEPTANCE OF THE CHANGE.

10. This Agreement will be governed by the laws of the United States and the State of California. Our failure to enforce your strict performance of any provision of this Agreement will not constitute a waiver of our right to subsequently enforce such provision or any other provision of this Agreement. (a screen similar to that shown in FIG. 22, modified to facilitate the desired submittal, may be inserted here and, or, a separate web site or page, a name, telephone number, email address and, or, address may be provided here).

Example “Errors & Problems”

Notice any errors or problems with the NorthStar, such as a broken link, misspelled words, wrong punctuation, wrong information, bad links, viewing problems or excessive loading time? We want to hear from you, please click here: (a screen similar to that shown in FIG. 22, modified to facilitate the desired submittal, may be inserted here and, or, a separate web page or site, a name, telephone number, email address and, or, address may be provided here).

Example “Comments & Suggestions”

We would appreciate your feedback, whether good or bad, and any suggestions that you may have for improving the NorthStar, please click here: (a screen similar to that shown in FIG. 22, modified to facilitate the desired submittal, may be inserted here and, or, a separate web page or site, a name, telephone number, email address and, or, address may be provided here).

Example “Business Opportunities”

Companies and individuals interested in partnering with NorthStar should contact us by sending an email to: (a separate web page or site, a name, telephone number, email address and, or, address may be provided here).

Example “Overview”

For many centuries, mariners and explorers used the North Star to guide them to their destination. Today, our NorthStar provides a pathway to the desired information that one seeks within a subject domain.

If you are exploring a wilderness area, there is nothing more important than a good map. The map will allow you to quickly put the terrain in context and find the best route from where you are to where you want to go. That is exactly what the NorthStar accomplishes—it presents an intuitive graphical view of the subject domain so you can put it in perspective and find the specific information that you seek. The NorthStar provides you the means to understand what you want and then provides you with the most credible and relevant information available on the internet pertaining to that topic.

We are drowning in a sea of unstructured data, but at the same time we frequently lack the required information to make an informed decision. All of th data that one may ever need is now available on the internet. However, because most of it is in an unstructured form and because we don't have a structural view of the concepts and ideas within a subject domain, we frequently can't precisely define what we seek nor locate the best information available online.

The most common way of finding data on the internet is by using a key word search engine. However, this approach is at best a “hit and miss” proposition with many limitations:

The search engine results only indicate that a word can be found within documents, but it doesn't indicate that the word was used in the proper context. The first page of a recent key word search for the word “jazz” on Google, showed links to an online magazine about jazz music, “Jazz” a PBS film by Ken Burns, as well as, the Utah Jazz basketball team. However, if you were looking for a computer product call “Jazz” from HP, you won't find it for many pages.

Search results will frequently produce a voluminous list of documents, too large to be reviewed. The above query under the word “jazz” returned approximately 13,400,000 listings. Research has shown that less than 5% of the users will go beyond the third page of search results, frequently leaving countless documents with valuable data unseen.

Many cash strapped search engines accept payment for top placement in the search results. The actual results may be just paid ads in disguise. Companies that have engaged in this practice have included Yahoo, AOL, Microsoft, Lycos and others.

In the best case scenario, search results are given priority position as a result of an algorithm, which may be based, in part, upon the number of incoming links to the site. It is possible that a site containing the most relevant content, but lacking incoming links, may be relegated to the last page of search results and therefore never seen.

Many web sites deploy optimization strategies to manipulate search engine results to increase the probability of being included in the top tier of search results, whether or not their site has any substantive or relevant content pertaining to the respective search words.

Very often the search engine results are not productive because few users know precisely what they are looking for or they may not understand the interconnecting relationships between concepts and ideas within a particular subject domain, thereby further limiting their ability to search.

Entering the wrong key words, which occasionally happens, will only produce bad results. Garbage in will always get garbage out.

Search engines can not access the accuracy or credibility of the online resources that are set forth in their search results. If you did a search under the key words “Elvis Presley,” you will likely discover that Elvis is alive and well, which may even be bolstered by testimonials of recent sightings.

The NorthStar avoids these problems by providing a visual map of an intrinsic order to the most important concepts and ideas within a specific subject domain. Also, because association plays an important role in learning, our visual map sets forth the relationships and associations between the various concepts and ideas. As a result of our extensive research and consultation with subject matter experts, if you click on a topic, you will find links to the best internet resources that we have been able to locate for that topic.

Example “Strategy”

The NorthStar business model embraces a discovery driven strategy. At the bedrock of our strategy is a belief that as a result of variations, randomness and complexity an outcome can not be predicted and the best way of achieving an objective is through short-term planning focused on hypothesis testing and pilot programs.

The central tenets of our discovery driven strategy are based upon the following guiding principles:

In the perfect world, one should seek to achieve the ideal final result (product, process or function) without expending resources (money, time, energy, etc.). Although this objective may not be achievable in most cases, it will none-the-less drive our process for innovation. Instead of spending money to solve a problem or find a solution, our focus will be on leveraging creativity, knowledge and existing resources to achieve the desired result with the absolute minimal expenditure of resources.

The oldest and most enduring scientific process is trial and error method and it's the critical component of our strategy. Improvements and innovative solutions come as a direct result of multiple iterations. Our focus will be on directed evolution of development and on reducing the number of trials to achieve the ideal final result. We will keep what works and toss the rest, but always looking for those unexpected opportunities, which we will quickly exploit.

Nothing is right the first time, so there should be quick and dirty prototypes and pilot programs, so we learn what works and what doesn't. If something fails, we won't stay still, but immediately try something new.

The faster we learn, the shorter the cycle time for development and the more competitive we will become. We will implement a system of continuous and accelerated feedback loops.

Establishment of an ongoing program of anticipatory failure analysis to detect potential problems before they happen, and to formulate and implement the best solution.

NorthStar's initial pilot project is the “Diving NorthStar” which targets the subject domain of scuba diving. The “Diving NorthStar” will serve as an incubator to develop, test and validate theories and functional applications, and various pathways to profitability.

We will expand the NorthStar on an incremental basis only after measurable success from generating money making tangible transactions. As we learn from our experience and have validated our theories, we will then launch NorthStar applications for other subject domains. The possibilities are infinite and limited only by one's imagination, here are a few examples of possible niche markets that we may target: high school football, skiing, fly fishing, golfing, biking, gardening, and boating.

Companies and individuals interested in partnering with NorthStar should contact us by sending an email to: (a screen similar to that shown in FIG. 22, modified to facilitate the desired submittal, may be inserted here and, or, a separate web page or site, a name, telephone number, email address and, or, address may be provided here).

It should be understood that a print and, or, save function may be incorporated in an EIAS. The print feature may be configured such that selection will result in the extent of the viewing window 101 being automatically sized to fit on one substantially full page of the associated operating system's default printer. The print feature may be configured to such that the extent of the EIAS VISUAL INTERFACE is printed to one page. The print feature may be configured to provide user selectable printing features similar to ones known in the art. Alternatively, the “print page” feature may be utilized. The save feature may be similarly configured, however, rather than printing the corresponding matter it is saved in a common format. Alternatively, the format may be user selectable.

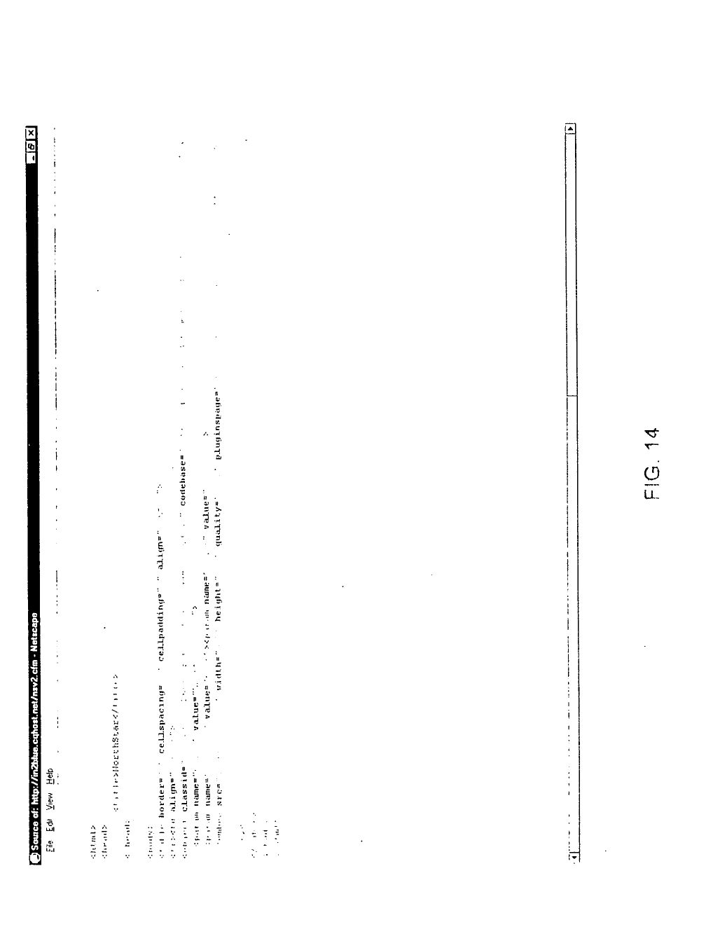

Turning now to FIGS. 13, 14 and the “HTML embedded FLASH file” code included below, an embodiment of an EIAS is depicted to be configured as a web page running within NetScape. It should be understood that one of ordinary skill in the art may configure the EIAS to run within any commonly available operating system in addition to the specific examples included herein. It should additionally be understood that one of ordinary skill in the art may configure the EIAS to include at least one tool bar and, or, at least one menu item similar to those incorporated in Safari, NetScape, Internet Explorer, OPERA, Mozzila Microsoft Windows, Northern Lights, AOL, MSN, etc.

It should be understood that an EIAS may be configured to allow a user to define the subject domain, subject topics, sub-subject topics and, or, topic links utilizing integrated tools. Related EIASs may incorporate known drawing and, or, linking features as incorporated in AutoCAD, Adobe Illustrator, geographic information systems, etc.

The tool bar items and, or, menu items may be configured to comprise mouse over selection functionality, clickable selection functionality or partially mouse over/partially clickable selection functionality.

Example “HTML embedded FLASH file” code

```
<html>
<head>
    <title>NorthStar</title>
</head>
<body>
<table border=“0” cellspacing=“3” cellpadding=“3” align=“center”>
<tr><td align=“center”>
<object classid=“clsid:D27CDB6E-AE6D-11cf-96B8-444553540000”
codebase=“http://download.macromedia.com/pub/shockwave/cabs/flash/swflash.cab#version =6,0,29,0”
width=“607” height=“571”>
  <param name=“movie” value=“NSint6_13.swf”>
  <param name=“quality” value=“high”><param name=“SCALE” value=“exactfit”>
  <embed src=“NSint6_13.swf” width=“607” height=“571” quality=“high”
pluginspage=“http://www.macromedia.com/go/getflashplayer” type=“application/x-
shockwave-flash” scale=“exactfit”></embed></object>
</td></tr>
</table>
</body>
</html>
```

FIG. 13 depicts the NetScape “View” toolbar item selected with “Page Source” highlighted as a result of the user moving a cursor over the “Page Source” menu item. Once the user clicks on the “Page Source” menu item, the page depicted in FIG. 14 is presented. The above “HTML embedded FLASH file” code is what is depicted within the page of FIG. 14.

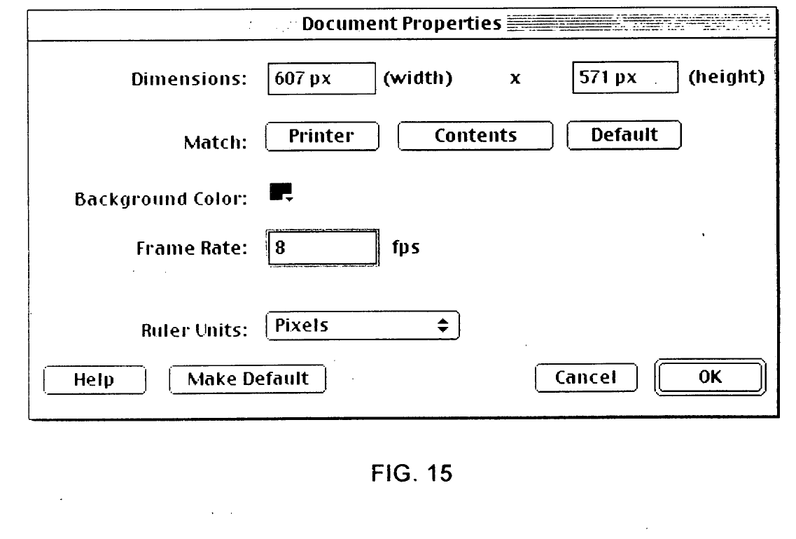

Turning now to FIGS. 15-21, preferred methods of creating an EIAS are described. In should be understood that the individual EIAS features and functionality may be employed in combinations and sub-combinations depending on desires of the author's(s') and, or, user's(s') preferences. One of ordinary skill in the art will recognize many variations of the code contained within the following EIAS creation examples that will facilitate the desired EIAS functionality in accordance with the present invention. Various EIAS creation examples are described with reference to FLASH MX and Action Script, available from Macromedia, Inc.; FIREWORKS, available from Macromedia, Inc.; Hyper Text Mark-up (HTML); KHTML; JAVA; XHTML; XML; CSS; ECMAScript; the DOM; JavaScript; COLDFUSION and CFML, available from Macromedia, Inc.; and structured query language (SQL) and SQL server database, available from Microsoft, Inc. It should be understood that at least portions of an EIAS may be created using other similarly software providing similar functionality, like for example, DIRECTOR, available from Macromedia, Inc.; QUICKTIME, available from Apple, Inc.; C; visual C; C++; visual C++; visual basic; Real Player; Adobe Illustrator, available from Adobe; and MediaPlayer (MP), available from Microsoft, Inc.

Example EIAS Creation 1

The .swf file, included in the code of FIG. 14 “NSint6_{—}13.swf” is preferably derived from a related file created using FLASH MX and is preferably “embedded” in the HTML code as shown.

Initially, it is useful to define some file related terms. A .fla file is preferably created using FLASH MX and Action Script (FLASH MX is the version contemporary with filing of this patent application). The fla file is preferably saved and then exported to become a .swf file. Typically, when “FLASH on the web” is mentioned, the reference is to a .swf file that has been embedded in a html page. Preferably, the .swf file is embedded in a html page and is treated like a web object within a web page similar to a picture (.jpg, gif, or .png), however, resembles something closer to a .pdf or a video object (.mpeg, .wmv, .mov, .rmv), because it requires a plug-in. Macromedia, Inc., the source for FLASH, has worked incredibly hard to license the associated plug-in to browser releases in the last four years. The response to authoring in FLASH content has resulted in a quite large audience downloading related plug-ins. Therefore, FLASH is very safe and provides a nearly universal tool for authoring at least a portion of an EIAS as will become apparent to one of ordinary skill in the art upon reading this disclosure. It should be understood that at least one EIAS embodiment of the present invention does not rely upon a plug-in, ActiveX component or applet to interact with a web browser. In at least one related embodiment, either HTML, SHTML, XML, CSS, JavaScript/ECMASript, the DOM, other world wide web standard code, a sub-combination or combination thereof is employed to create at least a portion of the EIAS. It should be understood that an EIAS may be at least partially created utilizing FLASH and, or, COLDFUSION similar to as described herein and configured such that no plug-in is required. Related EIAS embodiments may be configured to be viewed on the screen of a cellular telephone or a like sized screen.

FLASH is a time and frame based authoring application. Imagine a video cassette recorder (VCR) with a video in it, for example; when play is selected, the video plays at 29.97 fps (frames per second) on a TV screen typically sized at 640×480 resolution. FLASH PLAYER is synonymous with a VCR, an EIAS created with FLASH is synonymous with the video. However, in the case of FLASH, due to the fact that it is designed for computer applications, playback speed and screen resolution are typically unknown and generally are quite divergent from computer to computer.

Turning to FIG. 15, to accommodate the uncertainty of the end users' computer, the EIAS may be established at 8 fps for example. Preferably, two frames are used (as described in detail herein, one of the frames is preferably used to update associated variables of the other frame, facilitate button symbol counts, positioning of the concept map or identifying that the concept map reached an edge in a particular direction, or the like). As described herein, the individual direction arrows associated with the navigation interface encompass a host of functions, the associated configuration exploits the two frame arrangement. A low frame rate is preferably used because the slower frame speed assists in establishing the desired concept map view. This also helps code development and is friendlier to older computers as they try to rewrite to their associated screen(s).

The size of our stage (the part the user sees) is preferably set to 607×571 as shown in FIG. 15. This size was determined from the example concept map 310a depicted as “Diving NorthStar” discussed herein. It should be understood that other frame rates and, or, stage sizes are within the scope of the present invention and may be revised as the related hardware, firmware and software evolve. User selectable frame rate and, or, stage size is envisioned for alternate EIAS embodiments. It should be understood that as computer related hardware, firm ware and software evolve, the frame size and, or, speed may be revised.

Preferably, the background color is set to a “safe” #000066. Preferably, the concept map is within a mask, meaning only a certain portion of the concept map is visible and only corresponding subject topics and, or, sub-subject topics selectable at a given time. Preferably, the concept map “floats” on a surface of blue, therefore, no blue objects are required to be loaded to create the “illusion” of an interface.

In this example EIAS, there are preferably at least three types of symbols used in FLASH: 1) graphic symbols, 2) button symbols and 3) movie symbols. “Graphic symbols” are just what the name implies, these symbols may be used to define a shape of a particular button symbol for example. “Movie symbols” are independent FLASH movies that have their own timelines, animations, graphics, graphic symbol, button symbol, etc. that can be controlled by an associated main time line. Finally, “button symbols” may be made up of graphic and, or, movie symbols and have actions assigned to them (i.e. launch web pages, call variables, etc.). Optionally, at least one button symbol may be configured as a movie symbol (or Movie Clip) facilitating additional flexibility when compared to use of a button symbol. Button symbols require mouse, keyboard, or other input device events to activate. Movie symbols can act on events and an event can simply be showing up when they load. A symbol may incorporate an object, like a graphic, button, or sound file that is stored in a library and then reused throughout the EIAS VI. A symbol's properties like color and size may be modified and then animated within FLASH. A benefit of a symbol is that once the symbol is loaded, it can be reused repeatedly to create many unique buttons and, or, interfaces without needing to be loaded for each button or interface.

In the case of Diving Northstar, for example, which has over 100 sub-subject topics in the concept map 310a, one black square is created and turned into a graphic symbol. This graphic symbol is preferably integrated within a button symbol to define the subject topics and, or, a sub-subject topics. This button symbol is then populated to all of the subject topics and, or, sub-subject topics. Each subject topic and sub-subject topic is then assigned its own specific URL and function. When the associated Diving NorthStar .swf file is launched, the only thing that needs to be loaded for all the subject topics and sub-subject topics to come to life is one black rectangular graphic symbol that is only a matter of bytes.

Alternatively, an image may be used directly embedded in an HTML page. An image is typically made with at least one .gif file, jpg file or the like. The EIAS user would need to wait for all the individual images to download before they could see the concept map and use the EIAS.

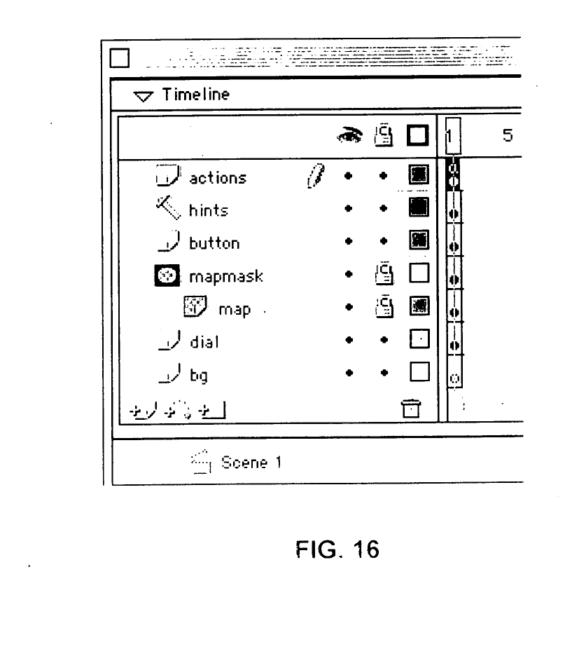

Subsequent to establishing the frame rate, the stage size and background color, the next step is preferably to set up the individual layers of a timeline (commonly referred to as a “root” directory) as shown in FIG. 16. Preferably, from top to bottom, the layers are: 1) actions; 2) hints; 3) button; 4) mapmask, preferably with sub-layer 4a) map; 5) dial and 6) bg (for background).

Since the mapmask layer along with its sub-layer map are preferably configured to provide the functionality associated with viewing a portion of a concept map within a viewing window, these layers will be discussed first. Mapmask is preferably defined by a graphic symbol named “blsquare”. Preferably, blsquare is colored close to green; this provides a functional reference. The mapmask layer's function is to define the shape and size of what the viewer sees of the corresponding map sub-layer.

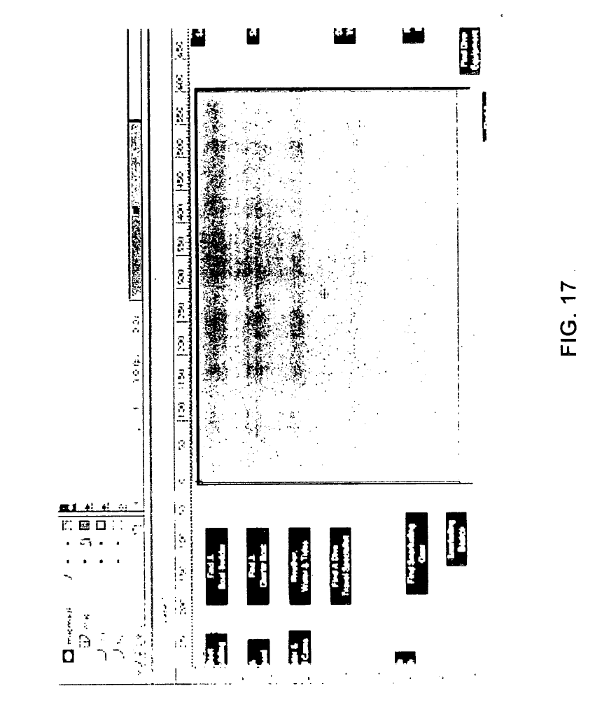

Preferably, as depicted in FIG. 17, the mapmask is set with width=601.1, height=400.9, with all positioning referenced to the top left corner (i.e. x=1.9, and y=2.5).

Preferably, the map sub-layer contains a movie symbol “map_mc” (an acronym for map movie clip) and is preferably given the defining name “map_slider”. This naming convention is preferred such that the movie symbol map_mc may be controlled from another movie symbol timeline; specifically the timeline of “actionClip”, in the actions layer, is preferably used to control map_mc as described in detail herein. Map_mc preferably is positioned on the stage with width=2022.3, height=1360.8, x=−637.8, and y=−335.1.

Inside map_mc is preferably a concept map created at least in part utilizing vector based graphics comprising text, lines, FLASH symbols, and a subject domain logo. Preferably the concept map is completely editable and scalable. Preferably the concept map is created such that it defines a graphic symbol and has a nested file named “map_final2.swf”. Code can not be assigned to a graphic symbol, therefore, in this example EIAS the map_final2.swf file is sown in. Each of the sub-subject topics is preferably created from a button symbol called BL Square button symbol having a nested graphic symbol. Preferably, the associated text 346, 546 is configured to “float” above the corresponding button symbol as apposed to being incorporated directly in the button symbol, otherwise, every sub-subject topic would need its own unique button symbol instead of “recycling” one as described in detail herein. Preferably, each of the button symbols is sized as desired by importing a corresponding Adobe Illustrator file and converting it, at least in part, to a vector base image file. Use of the most recent version of Adobe Illustrator eliminates this step, in that exporting symbols in a .swf format is built in. The following code, for example, is associated with the sub-subject topic button symbol associated with the “Find a Boat Builder” in the action script panel:

```
        on (release) {
    getURL(“ns.cfm?id=116”, “_blank”);
}
```

Preferably, this same code is associated with each sub-subject topic button symbol modified by URL, as described herein.

Preferably the following functionality is built into the concept map as GO TO button symbols. The GO TO buttons are preferably configured as “branches” from sub-subject topics that share similar links 150 and reside in spatially separated portions of the concept map, for example. In Diving NorthStar, for example, “Underwater Vehicles” and “Commercial Diving Companies” both have “Underwater Vehicles” associated therewith. A GO TO button preferably created from a BL Square button symbol is provided to “associate” spatially displaced subject topics and, or, sub-subject topics. Preferably, substantially the exact X and Y placement is targeted within the action window for placement of the concept map relative the viewing window as defined by the following code:

Code for the Go To Underwater Vehicle:

```
on (release) {
setProperty(“_root.map_slider”, _x, “95”);
    setProperty(“_root.map_slider”, _y, “204”);
    tellTarget (“underH20vehicle”) {
    nextFrame( );
    }
}
```

Code for the Go To Wreck and Diving:

on (release) {
setProperty(“_root.map_slider”, _x, “−175”);
setProperty(“_root.map_slider”, _y, “−300”);
tellTarget (“deepDiving”) {
nextFrame( );
}
}

Code for the Go To Find a Shipwreck:

on (release) {
setProperty(“_root.map_slider”, _x, “−325”);
setProperty(“_root.map_slider”, _y, “550”);
tellTarget (“findShipwreck”) {
nextFrame( );
}
}

Code for the Go To Field Guides:

```
on (release) {
    setProperty(“_root.map_slider”, _x, “925”);
    setProperty(“_root.map_slider”, _y, “−225”);
    tellTarget (“fieldGuides”) {
        nextFrame( );
    }
}
```

As shown in FIGS. 8 and 9, the concept map preferably has a gold border 880, 981, 982 that is created from the graphic symbol blsquare with tint=#FF9900, width=2022.3, height=1360.8, x=34.5, y=108.7. The border gives a user a visual cue that the concept map has a finite navigation associated with it. Preferably, the concept map stops moving when the border is encountered.

Preferably, the subject domain logo 130 is compressed in FIREWORKS MX, or the like, as a .jpg in order to retain the color gradient from the lower left hand corner 131 to the upper right hand corner 132. A .jpg may be used for images with more than 256 colors such that associated data compression algorithms will not drop the subtle in-between (gradient) colors.

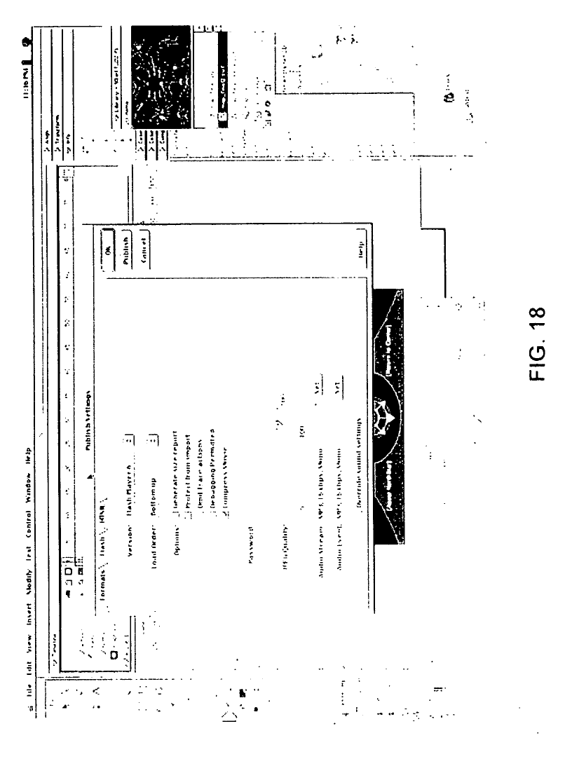

At this point, it is preferable to lock down the mapmask layer as depicted in FIG. 18.

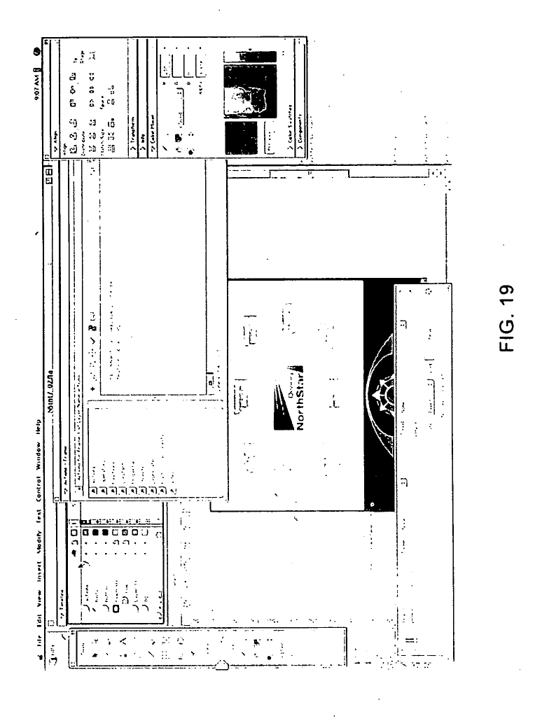

Preferably, the actions layer facilitates at least one of the following two functions: 1) it “houses” a movie symbol named “actionClip” and 2) sets the main timeline overall rules. In the action panel of FLASH the following code is preferably written as shown in FIG. 19:

```
        // reset your variables in the first frame
fscommand(“allowscale”, “false”);
testVariable = 0;
    note: “//” tells the computer to pass over the line. This is a means to
leave instructions (“comments”) and keep things organized.
```

The fscommand (“allowscale”, “false”); instruction sets the EIAS VISUAL INTERFACE such that it is not allowed to be scaled in size. Though .swf files are generally scalable by percentages, this instruction is used as a precaution to lock the scale to fixed sizes. For example, if it were scaled by 50% it may still work the same for some computers, however, it may misalign the x and, or, y placement of the concept map on other computers.

The testVariable=0; instruction functions with any variable to set it to 0 (i.e. false or OFF). This is preferable, because in this example button symbols are used to turn variables to an ON state and this instruction is what resets them.

The actionClip can be thought of as the “brain” of at least one FLASH based EIAS. As a movie symbol it has its own timeline and sub-layers. Because it isn't a graphic, in the Diving NorthStar for example, which adds to the presentation, it is preferably shrunk down to a width=0, height=0, x=18.5, and y=424.2; The actionClip only needs to be present, it does not need to be visible. An EIAS author can double click on the actionClip to open it. Preferably, the actionClip has only one layer named “actions”, having two frames. FLASH does not typically function well with only one frame. Therefore, a second frame is preferably employed to reset variables and function as described herein.

With the actions panel open, an author may select frame two, and type:
gotoAndPlay(1);

The changing input comes from variables and the variables are filled with the changing position of the map. When configured in this fashion FLASH needs a loop. The gotoAndPlay(1); tells it to go to frame one and play. Preferably, frame one does not have a condition to stop it; preferably, frame one is configured to automatically proceed to frame two.

With the actions panel open, select frame one. Preferably, frame one contains code that is written in the action panel. The following code is preferably written in the action panel:

// get positions of sliding objects
mapH = getProperty(“_root.map_slider”, _x);
mapV = getProperty(“_root.map_slider”, _y);

Preferably, two variables are set up for map_mc referred to as “map_slider” that is up one level on another timeline named, “_root”. One variable is preferably configured to determine the desired horizontal position of the concept map and the other variable is configured to determine the desired vertical position at all times:

slideRight = (_x+1)/1;
slideRightStop = (mapH−mapH);
slideLeft = (_x−1)/1;
slideLeftStop = (mapH+mapH)
slideUp = (_y+1)/50;
slideUpStop = (mapV−mapV);
slideDown = (_y−1)/50;
slideDownStop=(mapV+mapV);

The above variables are preferably configured to control the direction and speed of the concept map movement.

//if (Number(_root.testVariable) == 0){ }

The above instruction determines if the variables return 0 and tell the concept map not to move if a 0 is returned because nothing is happening.

```
    //tell the sliding object to W(go west)
    if (Number(_root.testVariable) == 1)
    if (Number(mapH)>=905){setProperty (“_root.map_slider”, _x,
mapH-slideRightStop);}
    else
    {setProperty (“_root.map_slider”, _x, slideRight+mapH);}
```

The above code establishes a first of many communications between the navigation arrows, the concept map and the position of the concept map. As can be cleaned from reviewing the code included herein, each arrow of the navigation interface encompasses use of movie symbol and button symbol functionality sown together. Each button symbol associated with the navigation interface preferably has a declared variable associated with it. For example, the left, 9 o'clock, arrow (or west arrow) is a button with a 1 associated with it; when selected, this button sends the 1 to the “brain” and moves the concept map _root.map_slider horizontally to the furthest x point west allowed by slideRightStop. If the horizontal position of the concept map is already at the x point, it is caught in a loop of being told to keep going by the slideRight+mapH instruction and the “else” instruction telling it that it can not go any further. The above code is preferably repeated for each desired navigation direction as follows:

```
    //tell the sliding object to NW
    if (Number(_root.testVariable) == 2)
    if (Number(mapH)>=910){setProperty (“_root.map_slider”, _x,
mapH-slideRightStop);}
    else
    if (Number(mapV)>=540){setProperty (“_root.map_slider”, _y,
mapV-slideUpStop);}
    else
    {setProperty (“_root.map_slider”, _x, mapH+slideLeft);
    setProperty (“_root.map_slider”, _y, mapV+slideUp)}
    //tell the sliding object to slide N
    if (Number(_root.testVariable) == 3)
    if (Number(mapV)>=540){setProperty (“_root.map_slider”, _y,
mapV-slideUpStop);}
    else
    {setProperty (“_root.map_slider”, _y, mapV+slideUp);}
    //tell the sliding object to NE
    if (Number(_root.testVariable) == 4)
    if (Number(mapV)>=540){setProperty (“_root.map_slider”, _y,
mapV-slideUpStop);}
    else
    if (Number(mapH)<=−450){setProperty (“_root.map_slider”, _x,
mapH-slideRightStop);}
    else
    {setProperty (“_root.map_slider”, _x, mapH-slideRight);
    setProperty (“_root.map_slider”, _y, mapV+slideUp)}
    //tell the sliding object to slide East
    if (Number(_root.testVariable) == 5)
    if (Number(mapH)<=−455){setProperty (“_root.map_slider”, _x,
mapH-slideRightStop);}
    else
    {setProperty (“_root.map_slider”, _x, mapH-slideRight);}
    //tell the sliding object to SE
    if (Number(_root.testVariable) == 6)
    if (Number(mapH)<=−450){setProperty (“_root.map_slider”, _x,
mapH-slideRightStop);}
    else
    if (Number(mapV)<=−400){setProperty (“_root.map_slider”, _y,
slideUpStop+mapV);}
    else
    {setProperty (“_root.map_slider”, _x, mapH-slideRight);
    setProperty (“_root.map_slider”, _y, mapV-slideDown)}
    //tell the sliding object to slide South
    if (Number(_root.testVariable) == 7)
    if (Number(mapV)<=−400){setProperty (“_root.map_slider”, _y,
slideUpStop+mapV);}
    else
    {setProperty (“_root.map_slider”, _y, mapV-slideDown);}
    //tell the sliding object to slide SW
    if (Number(_root.testVariable) == 8)
    if (Number(mapH)>=905){setProperty (“_root.map_slider”, _x,
mapH-slideRightStop);}
    else
    if (Number(mapV)<=−400){setProperty (“_root.map_slider”, _y,
slideUpStop+mapV);}
    else
    {setProperty (“_root.map_slider”, _x, mapH+slideLeft);
    setProperty (“_root.map_slider”, _y, mapV-slideDown)}
```

Preferably, the only item included in on the “hints” layer is the text and an arrow pointing to where the actionClip symbol is hidden.

The “button” layer is preferably made up of only one button symbol called “button1_mc”. Alternatively, this symbol may be configured as a movie symbol (or Movie Clip) facilitating additional flexibility when compared to use of a button symbol. As stated elsewhere herein, button symbols require mouse, keyboard or other input device events to activate; movie symbols can act on events and an event can simply be showing up when they load. The following code is preferably incorporated in the button1_mc instance associated with the 9 o'clock (or the west) position:

onClipEvent (load) {
thisButton = 1;
}

This instruction insures that the EIAS cannot start working until everything is loaded; no false starts will occur. Once this instruction is loaded, the button symbol can only have a value of 1; there is no confusion that upon a “Mouse Over” event that this button only equals 1 and the concept map will head West. By defining all movie symbols in this way, periods of inactivity will equal 0. Thereby, the EIAS knows to not move the concept map and allows the user to read and, or, select the sub-subject topics.

Each button1_mc starting at the West position with the variable of 1 and moving clockwise preferably has the following “on ClipEvent (load)” code attached in the action panel. The diagonals are preferably also labeled like compass points (i.e. NE, SE, NW and NE):

onClipEvent (load) {
thisButton = 2 ;
}

Also on the button layer are preferably four small, two pixel high, “shims” preferably derived from the blsquare graphic symbol, colored gray (#333333) and placed around the mapmask to give the EIAS VISUAL INTERFACE an outline. This is just to “pop” the EIAS VISUAL INTERFACE out against the associated background and preferably is located on a layer above the mapmask such that it is visible.

Preferably, the “dial” layer holds the few graphic elements of the visual interface along with two button symbols: 1) “About NorthStar” and 2) “Return to Center” in the Diving NorthStar example EIAS. Preferably, these two button symbols are configured as text turned into button symbols with gold “mouse over” states. The following associated code is preferably written in the actions panel:

For “About NorthStar” (for a fixed pop-up window):

```
    on (release) {
    g tURL(“javascript:openNewWindow(‘ns.cfm?id=aboutns.cfm’,
‘aboutNS’,‘height= 480,width=640’)”);
    }
```

For “Return to Center”:

```
on (release) {
    setProperty(“_root.map_slider”, _x, “295”);
    setProperty(“_root.map_slider”, _y, “204”);
}
```

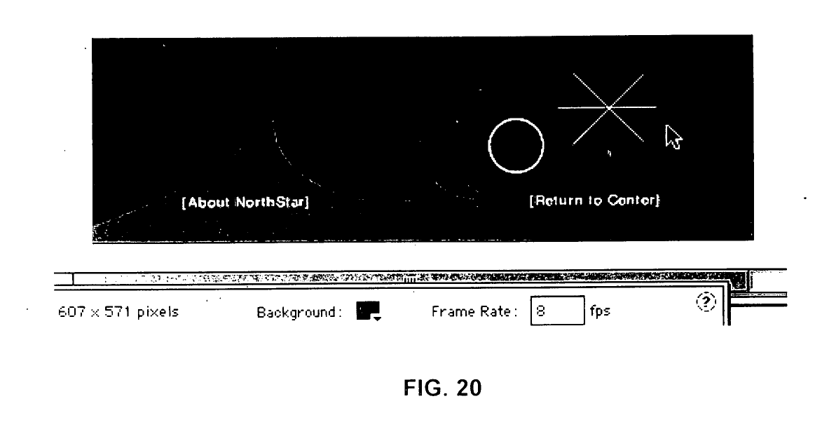

Turning now to FIG. 20, a graphic symbol named “bicircle”, a black circle, is preferably created, color matched and layered to provide a desired “line art” look. This assists in reducing the EIAS VISUAL INTERFACE file size and removes pixilated edges.

The “bg” layer is preferably included as an empty layer that can be shuffled up or down. The bg layer is unused in this example.

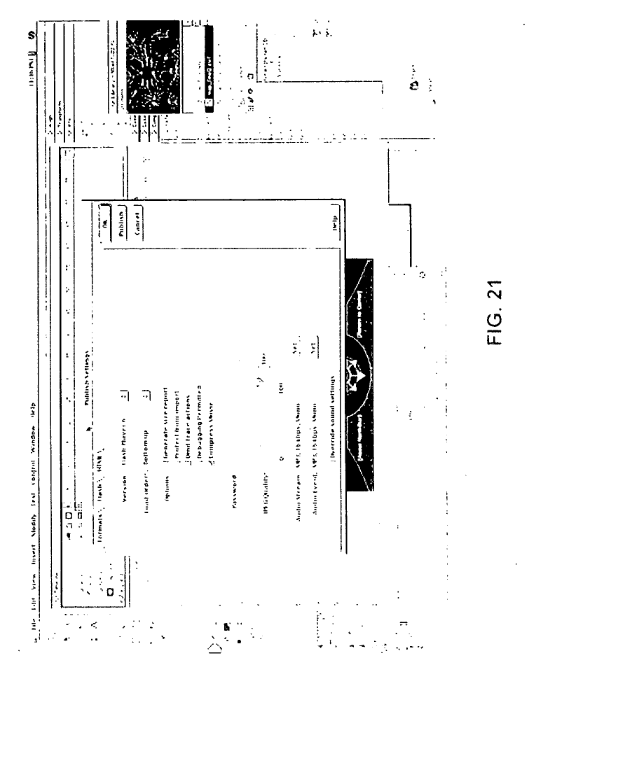

The final step is to set the export for the desired FLASH player (FLASH 6 player was used as shown in FIG. 21 for this example), this facilitates compression. Preferably, the author should elect to have it load from bottom up because the layers are preferably set up to have the user see the blue background. The dial layer is preferably loaded next and finally the biggest to load, the map layer, loads last. The EIAS VISUAL INTERFACE author may then publish and preview the EIAS as shown in FIG. 21.

Example EIAS Creation 2

This example provides a concept map, named “mapBig.gif”, similar to the concept map depicted in FIG. 3a, along with code that facilitates eight way, mouse over, navigation. Preferably JavaScript is utilized to create at least a portion of the code. The code described in this example also allows the user to “jump” to specific areas of the concept map with a GO TO button and also allows the user to reset the map to the default position using a “return to center” button.

A “layer” object principle is preferably used that has a “z” stacking order. The JavaScript code preferably controls the absolute position of the concept map layer. Layers are functional in 4+ browsers, which means this feature has been available for approximately the last thirty months at the time of filing of this application for patent.

The associated html page setup comprises at least two portions: 1) the head<head> and 2) the body<body>. The whole page starts by being declared as a html document <html> so a browser can begin to interpret it correctly.

<html>
<head>
<title>NS 10.16.03</title>
<meta http-equiv=“Content-Type” content=“text/html; charset=iso-8859-
1”>

The <head> preferably contains title information that is to be displayed at the top of a browser along with script functions that will be used in the remainder of the code. This allows the developer to put the bulk of the coding functions in the beginning and allows references to invoke the actual function to be carried out in the body. This organization facilitates “recycling” and minimizes typing time.

The type of code is defined using the following instruction. In this example, the browser is told that JavaScript is going to be used.

<script language=“JavaScript” type=“text/JavaScript”>
<!--

The order of the functions is discretionary. Following is JavaScript to facilitate the GO TO button that is preferably an image map designated by “GoTo Underwater Vehicles” in the concept map.

```
function MM_timelinePlay(tmLnName, myID) {
  var i,j,tmLn,props,keyFrm,sprite,numKeyFr,firstKeyFr,propNum,theObj,firstTime=false;
  if (document.MM_Time == null) MM_initTimelines( ); //if *very* 1st time
  tmLn = document.MM_Time[tmLnName];
  if (myID == null) { myID = ++tmLn.ID; firstTime=true;}//if new call, incr ID
  if (myID == tmLn.ID) { //if Im newest
    setTimeout(‘MM_timelinePlay(“‘+tmLnName+’”,‘+myID+’)’,tmLn.delay);
    fNew = ++tmLn.curFrame;
    for (i=0; i<tmLn.length; i++) {
      sprite = tmLn[i];
      if (sprite.charAt(0) == ‘s’) {
        if (sprite.obj) {
          numKeyFr = sprite.keyFrames.length; firstKeyFr = sprite.keyFrames[0];
          if (fNew >= firstKeyFr && fNew <= sprite.keyFrames[numKeyFr−1]) {//in range
            keyFrm=1;
            for (j=0; j<sprite.values.length; j++) {
              props = sprite.values[j];
              if (numKeyFr != props.length) {
                if (props.prop2 == null) sprite.obj[props.prop] = props[fNew-firstKeyFr];
                else  sprite.obj[props.prop2][props.prop] = props[fNew-firstKeyFr];
              } else {
                while (keyFrm<numKeyFr && fNew>=sprite.keyFrames[keyFrm]) keyFrm++;
                if (firstTime ∥ fNew==sprite.keyFrames[keyFrm−1]) {
                  if (props.prop2 == null) sprite.obj[props.prop] = props[keyFrm−1];
                  else  sprite.obj[props.prop2][props.prop] = props[keyFrm−1];
        } } } } }
      } else if (sprite.charAt(0)==‘b’ && fNew == sprite.frame) eval(sprite.value);
      if (fNew > tmLn.lastFrame) tmLn.ID = 0;
  } }
}
```

The following code functions as a test. It checks the position of the layer by the layers name. Naming an object as follows allows code to be assigned to it.

```
function MM_findObj(n, d) { //v4.01
  var p,i,x; if(!d) d=document; if((p=n.indexOf(“?”))>0&&parent.frames.length) {
    d=parent.frames[n.substring(p+1)].document; n=n.substring(0,p);}
  if(!(x=d[n])&&d.all) x=d.all[n]; for (i=0;!x&&i<d.forms.length;i++) x=d.forms[i][n];
  for(i=0;!x&&d.layers&&i<d.layers.length;i++) x=MM_findObj(n,d.layers[i].document);
  if(!x && d.getElementById) x=d.getElementById(n); return x;
}
```

The following code functions to move the corresponding layers. It sets an absolute position (i.e. top and left of the given layer) where the layer is suppose to go. In addition, the speed the layer moves is established, in this example 1 pixel per 60 msec.

```
function moveMap( ) {
  if (arguments.length < 4) {return;} var aA = arguments, sD = aA[0]; if (sD == “”)
{return;}
  var oD = eval(“MM_findObj(‘“ + sD + ’”)”); if (oD == null) {return;}
  var iNX = parseInt(aA[1]), iNY = parseInt(aA[2]), iS = parseInt(aA[3]);
  var iPx = (aA.length > 4) ? parseInt(aA[4]) : 0, iR = (aA.length > 5) ? parseInt(aA[5]):
0;
  var iT = 10, sS = “”; if (!document.layers) {oD = oD.style;} if (oD.tT != null)
{clearTimeout(oD.tT);}
  var iCX = parseInt(oD.left), iCY = parseInt(oD.top);
  if (iR != 0) { // relative
    if (iR == 1) {iNX = iCX − iNX; iNY = iCY;} // left
    else if (iR == 2) {iNX = iCX + iNX; iNY = iCY;} // right
    else if (iR == 3) {iNY = iCY − iNY; iNX = iCX;} // up
    else {iNY = iCY + iNY; iNX = iCX;}} // down
  var iX = iNX, iY = iNY; if ((iCX != iNX) ∥ (iCY != iNY)) {
    if (iPx > 0) { iT = iS;
      var iPxX = iPx, iPxY = iPx, iMX = Math.abs(iCX − iNX), iMY = Math.abs(iCY −
iNY);
      if (iMX < iMY) {iPxY = (iMX != 0) ? ((iMY/iMX)*iPx) : iPx;}
      else {iPxX = (iMY != 0) ? ((iMX/iMY)*iPx) : iPx;}
      if (iPxX >= iMX) {iPxX = Math.min(Math.ceil(iPxX), iPx);}
      if (iPxY >= iMY) {iPxY = Math.min(Math.ceil(iPxY), iPx);}
      if ((iCX < iNX) && (iCX + iPxX < iNX)) {iNX = iCX + iPxX;}
      if ((iCX > iNX) && (iCX − iPxX > iNX)) {iNX = iCX − iPxX;}
      if ((iCY < iNY) && (iCY + iPxY < iNY)) {iNY = iCY + iPxY;}
      if ((iCY > iNY) && (iCY − iPxY > iNY)) {iNY = iCY − iPxY;}}
    else {var iMX = ((iNX − iCX) / iS), iMY = ((iNY − iCY) / iS);
      iMX = (iMX > 0) ? Math.ceil(iMX) : Math.floor(iMX); iNX = iCX + iMX;
      iMY = (iMY > 0) ? Math.ceil(iMY) : Math.floor(iMY); iNY = iCY + iMY;}
    if ((parseInt(navigator.appVersion)>4 ∥ navigator.userAgent.indexOf(“MSIE”)>−1)
&& (!window.opera)) {sS=“px”;}
    if (iMX != 0) {eval(“oD.left = ‘“ + iNX + sS + ”’”);} if (iMY != 0) {eval(“oD.top = ‘“ +
iNY + sS + ”’”);}
    var sFunction = “moveMap(‘“ + sD + ”’,“ + iX + ”,“ + iY + ”,“ + iS + ”,“ + iPx + ”,0)”;
    oD.tT = setTimeout(sFunction,iT);}
}
//-->
</script>
<script language=“JavaScript” type=“text/JavaScript”>
```

The following code enables the “Return to Center” function. This code “reloads” the page, thereby, resetting the concept map to its default position.

```
<!--
function MM_reloadPage(init) { //reloads the window if Nav4 resized
  if (init==true) with (navigator) {if
((appName==“Netscape”)&&(parseInt(appVersion)==4)) {
  document.MM_pgW=innerWidth; document.MM_pgH=innerHeight;
onresize=MM_reloadPage; }}
  else if (innerWidth!=document.MM_pgW ∥ innerHeight!=
document.MM_pgH)
location.reload( );
}
MM_reloadPage(true);
```

The following code is also associated with the GO TO button. This code does not actually induce a “jump” to a physical place when the associated GO TO button is selected. In this case, a keyframe is inserted on the timeline with a script that stops the “playback head”. The concept map is, thereby, moved into the desired position. Layers can be attached to timelines usually used for simple keyframed animation, like making a logo move across the screen.

Illustratively, envision two sheets with a ball on them. Sheet 1(Keyframe 1) has the ball on the far left sheet 2(Keyframe 2) has the ball on the for right. The GO TO button switches the view of sheet 1 to sheet 2 so quickly that the ball appears to move across the sheet.

```
function MM_timelineStop(tmLnName) { //v1.2
  //Copyright 1997, 2000 Macromedia, Inc. All rights reserved.
  if (document.MM_Time == null) MM_initTimelines( ); //if *very* 1st time
  if (tmLnName == null) //stop all
    for (var i=0; i<document.MM_Time.length; i++) document.MM_Time[i].ID = null;
  else document.MM_Time[tmLnName].ID = null; //stop one
}
function MM_timelineGoto(tmLnName, fNew, numGotos) { //v2.0
  //Copyright 1997, 2000 Macromedia, Inc. All rights reserved.
  var i,j,tmLn,props,keyFrm,sprite,numKeyFr,firstKeyFr,lastKeyFr,propNum,theObj;
  if (document.MM_Time == null) MM_initTimelines( ); //if *very* 1st time
  tmLn = document.MM_Time[tmLnName];
  if (numGotos != null)
    if (tmLn.gotoCount == null) tmLn.gotoCount = 1;
    else if (tmLn.gotoCount++ >= numGotos) {tmLn.gotoCount=0; return}
  jmpFwd = (fNew > tmLn.curFrame);
  for (i = 0; i < tmLn.length; i++) {
    sprite = (jmpFwd)? tmLn[i] : tmLn[(tmLn.length−1)−i]; //count bkwds if jumping back
    if (sprite.charAt(0) == “s”) {
      numKeyFr = sprite.keyFrames.length;
      firstKeyFr = sprite.keyFrames[0];
      lastKeyFr = sprite.keyFrames[numKeyFr − 1];
      if ((jmpFwd && fNew<firstKeyFr) ∥ (!jmpFwd && lastKeyFr<fNew)) continue; //skip if
untouchd
      for (keyFrm=1; keyFrm<numKeyFr && fNew>=sprite.keyFrames[keyFrm];
keyFrm++);
      for (j=0; j<sprite.values.length; j++) {
      props = sprite.values[j];
      if (numKeyFr == props.length) propNum = keyFrm−1 //keyframes only
      else propNum = Math.min(Math.max(0,fNew−firstKeyFr),props.length−1); //or keep
in legal range
      if (sprite.obj != null) {
        if (props.prop2 == null) sprite.obj[props.prop] = props[propNum];
        else sprite.obj[props.prop2][props.prop] = props[propNum];
      } }
    } else if (sprite.charAt(0)==‘b’ && fNew == sprite.frame) eval(sprite.value);
  }
  tmLn.curFrame = fNew;
  if (tmLn.ID == 0) eval(‘MM_timelinePlay(tmLnName)’);
}
function MM_initTimelines( ) { //v4.0
    //MM_initTimelines( ) Copyright 1997 Macromedia, Inc. All rights reserved.
    var ns = navigator.appName == “Netscape”;
    var ns4 = (ns && parseInt(navigator.appVersion) == 4);
    var ns5 = (ns && parseInt(navigator.appVersion) > 4);
    document.MM_Time = new Array(1);
    document.MM_Time[0] = new Array(3);
    document.MM_Time[“Timeline1”] = document.MM_Time[0];
    document.MM_Time[0].MM_Name = “Timeline1”;
    document.MM_Time[0].fps = 15;
    document.MM_Time[0][0] = new String(“sprite”);
    document.MM_Time[0][0].slot = 1;
    if (ns4)
        document.MM_Time[0][0].obj = document[“map”];
    else if (ns5)
        document.MM_Time[0][0].obj = document.getElementById(“map”);
    else
        document.MM_Time[0][0].obj = document.all ? document.all[“map”] : null;
    document.MM_Time[0][0].keyFrames = new Array(1, 2);
    document.MM_Time[0][0].values = new Array(2);
    if (ns5)
        document.MM_Time[0][0].values[0] = new Array(“−65px”, “−232px”);
    else
        document.MM_Time[0][0].values[0] = new Array(−65,−232);
    document.MM_Time[0][0].values[0].prop = “left”;
    if (ns5)
        document.MM_Time[0][0].values[1] = new Array(“−161px”, “−161px”);
    else
        document.MM_Time[0][0].values[1] = new Array(−161,−161);
    document.MM_Time[0][0].values[1].prop = “top”;
    if (!ns4) {
        document.MM_Time[0][0].values[0].prop2 = “style”;
        document.MM_Time[0][0].values[1].prop2 = “style”;
    }
    document.MM_Time[0][1] = new String(“behavior”);
    document.MM_Time[0][1].frame = 1;
    document.MM_Time[0][1].value = “MM_timelineStop( )”;
    document.MM_Time[0][2] = new String(“behavior”);
    document.MM_Time[0][2].frame = 2;
    document.MM_Time[0][2].value = “MM_timelineStop( )”;
    document.MM_Time[0].lastFrame = 2;
    for (i=0; i<document.MM_Time.length; i++) {
        document.MM_Time[i].ID = null;
        document.MM_Time[i].curFrame = 0;
        document.MM_Time[i].delay = 1000/document.MM_Time[i].fps;
    }
}
//-->
</script>
</head>
```

The above code also closes the head and function defining area.

The following code, body, sets up what the user actually sees like images, text, bgcolor, etc. Preferably, the entire navigation is held in this layer and is preferably named “nav”. The following instruction sets the background color to black.

<body bgcolor=“#000000”>

The first layer is defined below with a “div id” tag and correspondingly named. Illustratively, layers may be thought of as boxes that can have adjustable sizes, contain images/text/links, be stacked on top of each other etc. These “boxes” are altered with code to provide individual functionality as desired.

```
<div id=“nav” style=“position:absolute; left:272px; top:377px; width:611px; height:177px;
z-index:2”>
<table width=“607” border=“0” cellpadding=“0” cellspacing=“0”>
  <tr>
    <td> <img src=“imagesNav/spacer.gif” width=“89” height=“1”></td>
    <td> <img src=“imagesNav/spacer.gif” width=“106” height=“1”></td>
    <td> <img src=“imagesNav/spacer.gif” width=“45” height=“1”></td>
    <td> <img src=“imagesNav/spacer.gif” width=“23” height=“1”></td>
    <td> <img src=“imagesNav/spacer.gif” width=“18” height=“1”></td>
    <td> <img src=“imagesNav/spacer.gif” width=“1” height=“1”></td>
    <td> <img src=“imagesNav/spacer.gif” width=“7” height=“1”></td>
    <td> <img src=“imagesNav/spacer.gif” width=“27” height=“1”></td>
    <td> <img src=“imagesNav/spacer.gif” width=“8” height=“1”></td>
    <td> <img src=“imagesNav/spacer.gif” width=“1” height=“1”></td>
    <td> <img src=“imagesNav/spacer.gif” width=“17” height=“1”></td>
    <td> <img src=“imagesNav/spacer.gif” width=“1” height=“1”></td>
    <td> <img src=“imagesNav/spacer.gif” width=“22” height=“1”></td>
    <td> <img src=“imagesNav/spacer.gif” width=“43” height=“1”></td>
    <td> <img src=“imagesNav/spacer.gif” width=“111” height=“1”></td>
    <td> <img src=“imagesNav/spacer.gif” width=“88” height=“1”></td>
    <td></td>
  </tr>
  <tr>
    <td colspan=“16”> <img src=“imagesNav/nav_01.gif” width=“607” height=“21”></td>
    <td> <img src=“imagesNav/spacer.gif” width=“1” height=“21”></td>
  </tr>
  <tr>
    <td colspan=“7”> <img src=“imagesNav/nav_02.gif” width=“289” height=“22”></td>
    <td rowspan=“2”> Here is the “moveMap” function being called to make the map
move South set onMouseOver state.
<a href=“javascript:;” onMouseOver=“moveMap(‘map’,−65,33,60,1,0)” Here is the
“moveMap” function being called to make the map move to equal Null which is why the
map stops moving when onMouseOut.
onMouseOut=“moveMap(‘map’,0,0,20,3,3)”><img src=“imagesNav/nav_03.gif”
name=“n” width=“27” height=“23” border=“0” id=“n”></a></td>
    <td colspan=“8” rowspan=“2”> <img src=“imagesNav/nav_04.gif” width=“291”
height=“23”></td>
    <td> <img src=“imagesNav/spacer.gif” width=“1” height=“22”></td>
  </tr>
```

Preferably, the above code is repeated for all directions of the navigation interface as follows:

```
  <tr>
    <td colspan=“4” rowspan=“4”> <img src=“imagesNav/nav_05.gif” width=“263”
height=“27”></td>
    <td colspan=“2” rowspan=“2”> <a href=“javascript:;”
onMouseOver=“moveMap(‘map’,266,33,60,1,0)”
onMouseOut=“moveMap(‘map’,0,0,60,1,1)”><img src=“imagesNav/nav_06.gif”
width=“19” height=“17” border=“0”></a></td>
    <td rowspan=“14”> <img src=“imagesNav/nav_07.gif” width=“7” height=“124”></td>
    <td> <img src=“imagesNav/spacer.gif” width=“1” height=“1”></td>
  </tr>
  <tr>
    <td colspan=“3” rowspan=“7”> <img src=“imagesNav/nav_08.gif” width=“36”
height=“62”></td>
    <td colspan=“2” rowspan=“2”> <a href=“javascript:;”
onMouseOver=“moveMap(‘map’,−527,33,60,1,0)”
onMouseOut=“moveMap(‘map’,0,0,60,1,2)”><img src=“imagesNav/nav_09.gif”
width=“18” height=“17” border=“0”></a></td>
    <td colspan=“4” rowspan=“3”> <img src=“imagesNav/nav_10.gif” width=“264”
height=“26”></td>
    <td> <img src=“imagesNav/spacer.gif” width=“1” height=“16”></td>
  </tr>
  <tr>
    <td colspan=“2” rowspan=“5”> <img src=“imagesNav/nav_11.gif” width=“19”
height=“45”></td>
    <td> <img src=“imagesNav/spacer.gif” width=“1” height=“1”></td>
  </tr>
  <tr>
    <td colspan=“2”> <img src=“imagesNav/nav_12.gif” width=“18” height=“9”></td>
    <td> <img src=“imagesNav/spacer.gif” width=“1” height=“9”></td>
  </tr>
  <tr>
    <td colspan=“3” rowspan=“7”> <img src=“imagesNav/nav_13.gif” width=“240”
height=“55”></td>
    <td> <a href=“javascript:;” onMouseOver=“moveMap(‘map’,266,−161,60,1,0)”
onMouseOut=“moveMap(‘map’,0,0,20,3,1)”><img src=“imagesNav/nav_14.gif”
name=“w” width=“23” height=“22” border=“0” id=“w”></a></td>
    <td rowspan=“4”> <img src=“imagesNav/nav_15.gif” width=“17” height=“36”></td>
    <td colspan=“2” rowspan=“2”> <a href=“#” onMouseOver=“moveMap(‘map’,−527,−
161,60,1,0)” onMouseOut=“moveMap(‘map’,0,0,20,3,2)”><img
src=“imagesNav/nav_16.gif” name=“e” width=“23” height=“28” border=“0”
id=“e”></a></td>
    <td colspan=“3” rowspan=“7”> <img src=“imagesNav/nav_17.gif” width=“242”
height=“55”></td>
    <td> <img src=“imagesNav/spacer.gif” width=“1” height=“22”></td>
  </tr>
  <tr>
    <td rowspan=“9”> <img src=“imagesNav/nav_18.gif” width=“23” height=“75”></td>
    <td> <img src=“imagesNav/spacer.gif” width=“1” height=“6”></td>
  </tr>
  <tr>
    <td colspan=“2” rowspan=“8”> <img src=“imagesNav/nav_19.gif” width=“23”
height=“69”></td>
    <td> <img src=“imagesNav/spacer.gif” width=“1” height=“7”></td>
  </tr>
  <tr>
    <td rowspan=“3”> <a href=“javascript:;” onMouseOver=“moveMap(‘map’,266,−
545,60,1,0)” onMouseOut=“moveMap(‘map’,0,0,60,1,1)”><img
src=“imagesNav/nav_20.gif” width=“18” height=“18” border=“0”></a></td>
    <td rowspan=“7”> <img src=“imagesNav/nav_21.gif” width=“1” height=“62”></td>
    <td> <img src=“imagesNav/spacer.gif” width=“1” height=“1”></td>
  </tr>
  <tr>
    <td colspan=“2” rowspan=“3”> <img src=“imagesNav/nav_22.gif” width=“35”
height=“19”></td>
    <td colspan=“2”> <a href=“javascript:;” onMouseOver=“moveMap(‘map’,−527,−
545,60,1,0)” onMouseOut=“moveMap(‘map’,0,0,60,1,2)”><img
src=“imagesNav/nav_23.gif” width=“18” height=“16” border=“0”></a></td>
    <td> <img src=“imagesNav/spacer.gif” width=“1” height=“16”></td>
  </tr>
  <tr>
    <td colspan=“2” rowspan=“5”> <img src=“imagesNav/nav_24.gif” width=“18”
height=“45”></td>
    <td> <img src=“imagesNav/spacer.gif” width=“1” height=“1”></td>
  </tr>
  <tr>
    <td rowspan=“4”> <img src=“imagesNav/nav_25.gif” width=“18” height=“44”></td>
    <td> <img src=“imagesNav/spacer.gif” width=“1” height=“2”></td>
  </tr>
  <tr>
    <td rowspan=“3”> <img src=“imagesNav/nav_26.gif” width=“89” height=“42”></td>
    <td> <img src=“imagesNav/nav_27.gif” width=“106” height=“13”></td>
    <td rowspan=“3”> <img src=“imagesNav/nav_28.gif” width=“45” height=“42”></td>
    <td rowspan=“2”> <a href=“javascript:;” onMouseOver=“moveMap(‘map’,−65,−
545,60,1,0)” onMouseOut=“moveMap(‘map’,0,0,20,3,4)”><img
src=“imagesNav/nav_29.gif” name=“s” width=“27” height=“22” border=“0”
id=“s”></a></td>
    <td rowspan=“3”> <img src=“imagesNav/nav_30.gif” width=“8” height=“42”></td>
    <td rowspan=“3”> <img src=“imagesNav/nav_31.gif” width=“43” height=“42”></td>
    <td> <a href=“jNS.html” target=“_self”><img src=“imagesNav/nav_32.gif”
width=“111” height=“13” border=“0”></a></td>
    <td rowspan=“3”> <img src=“imagesNav/nav_33.gif” width=“88” height=“42”></td>
    <td> <img src=“imagesNav/spacer.gif” width=“1” h ight=“13”></td>
  </tr>
  <tr>
    <td rowspan=“2”> <img src=“imagesNav/nav_34.gif” width=“106” height=“29”></td>
    <td rowspan=“2”> <img src=“imagesNav/nav_35.gif” width=“111” height=“29”></td>
    <td> <img src=“imagesNav/spacer.gif” width=“1” height=“9”></td>
  </tr>
  <tr>
    <td> <img src=“imagesNav/nav_36.gif” width=“27” height=“20”></td>
    <td> <img src=“imagesNav/spacer.gif” width=“1” height=“20”></td>
  </tr>
  </table>
</div>
```

Below is code defining the layer for the concept map as the “div id=“map”.

```
<div id=“map” style=“position:absolute; left:−65px; top:−161px; width:1408px;
height:920px; z-index:1; visibility: visible; overflow: hidden;”><img src=“mapBig.gif”
name=“Image1” width=“1408” height=“920” border=“0” usemap=“#Image1Map”>
    <map name=“Image1Map”>Here is the “GoTo” button image map, which is a target
made by defining a rectangle area of an image, in this case the NorthStar map:
    <area shape=“rect” coords=“390,40,467,89” href=“#”
onClick=“MM_timelineGoto(‘Timeline1’,‘2’)”>
    </map>
</div>
```

The following code defines four additional layers stacked on top of the concept map and the navigation interface to define the viewing window. The individual layers are set on the left, top, right, and bottom around the concept map and navigation interface. The layers are filled with a 5×5 pixel black image that is stretched to fit each layer box.

```
<div id=“blackL” style=“position:absolute; left:−17px; top:−78px; width:292px;
height:868px; z-index:4; visibility: visible;”><font color=“#FFFFFF”>
  <img src=“white.gif” width=“292” height=“868”> </font></div>
<div id=“blackB” style=“position:absolute; left:201px; top:545px; width:829px;
height:245px; z-index:5; visibility: visible;”><img src=“whit .gif” width=“830”
height=“271”></div>
<div id=“blackR” style=“position:absolut ; left:879px; top:−215px; width:474px;
height:1004px; z-index:6”><img src=“white.gif” width=“474” height=“1004”></div>
<div id=“blackTop” style=“position:absolute; left:1px; top:−19px; width:917px;
height:42px; z-index:7”><img src=“white.gif” width=“917” height=“44”></div>
<p>&nbsp; </p>
<MAP NAME=“map_516_Map”>
  <AREA SHAPE=“rect” ALT=“” COORDS=“0,0,124,36” HREF=“#”>
</MAP>
<!-- End ImageReady Slices -->
</body>
</html>
```

Example EIAS Creation 3

This example EIAS is described as being created with Photoshop and JAVA script software. As will become apparent, the navigation interface of this example is configured with clickable selection functionality.

Initially a Photoshop .jpg image of the concept map including the subject domain logo, the subject topics, the sub-subject topics and the links 150 is manipulated using the image slicing tools of Photoshop to create “image slices”. Preferably, each rectangle box is configured as a “slice” of the image; this is preferred because each rectangle is preferably “lit up” when a cursor is moved over it.

First, each rectangle subject topic and sub-subject topic is preferably placed in a different layer. After all the rectangles are in a separate layer, the desired mouse over “lit up” effect is created. Photoshop allows a macro to be recorded that automatically creates the lit up effect when the macro is played back.

To create the macro, one rectangle is selected and a mouse over state is created. The state is preferably then changed in such a way that it represents the lit up effect. After this macro is recorded, the macro is played and applied individually to each rectangle box. After the macro is applied to all the desired subject topics and, or, desired sub-subject topics, the Photoshop project is preferably saved as a HTML file. Photoshop is capable of automatically generating the desired JAVA code. This completes the HTML code for the desired mouse over effects for the subject topics and, or, sub-subject topics. In should be understood that an image compatible with the .png (“ping”) format may be employed.

Next, the 8-way navigation interface is created. To create the 8-way navigation, a desired 8-way navigation interface image is utilized and image slices are created in such a way that each arrow roughly represents a rectangular image (i.e. arrows are not rectangular). For each direction of the navigation interface an image click event is created.

Preferably, the concept map HTML file is placed in one HTML frame and the 8-way navigation interface in another HTML frame. Preferably, the image click event is coded in such a way that when clicked, the JavaScript code moves the whole concept HTML file (preferably in another frame) in the desired direction. For example, when the user clicks on the “up” (“N”) button, an “image_click” event is initiated and 50 is added to the y coordinate of the concept HTML, causing it to move down, thus allowing a user to induce movement of the concept map upward of the prior view.

PhotoShop is preferably used for image slicing of the rectangles and the 8-way navigation system. JAVA code is preferably used for the concept map movement effects. Separate HTML frames are preferably used and JAVA script code is preferably employed to move the concept map.

“Diving Northstar” is preferably designed having each sub-subject topic and relationships to each other represented by an image. Th EIAS is preferably configured as a set of slices of images. Some images are the subject topics and sub-subject topics and other images form the links that connect one subject topic and, or, sub-subject topic to one another. This is designed primarily to facilitate the mouse over event of which when a mouse is moved over a subject topic and, or, sub-subject topic represented by an image, the image changes color such that it appears to be lit up as if it is shined upon by a spot light.

The 8-way navigation system is preferably facilitated by shifting the entire set of images that are the subject topics and sub-subject topics and their relationship to one another, in the direction that the user desires.

Example EIAS Creation 4

Preferably, COLDFUSION, a product of Macromedia, Inc., and SQL Server, a relational database available from Microsoft Inc. are used in combination with an associated open database connectivity (ODBC) for this example EIAS creation. The dynamic information links functionality described herein is preferably accomplished using the code described in this example. This dynamic information links functionality may be incorporated with other EIAS functionality described herein.

When a user chooses a sub-subject topic from the EIAS, and clicks, preferably the following process ensues. A COLDFUSION page, (in this example named ns.cfm), is called from the EIAS server and executes the following COLDFUSION code:

<cfquery datasource=“in2blue” name=“q1”>
select url, xdesc, xtitle
from url
where subcat_id = #url.id#
</cfquery>

The above code constitutes a database “query”, and is preferably the actual code used to retrieve information relating to the user selected “url.id” value associated with a given sub-subject topic. For example, the value of url.id of “1” results in the following EIAS server interpretation of the code:

“ <cfquery datasource=“in2blue” name=“q1”> ”

The above code tells the EIAS server which database to access (in2blue) and what the name of the query is (q1). The query is named such that the results of the query may later be output for display to the user as shown in FIG. 7.

“select url, xdesc, xtitle”

Of the available fields in the database, the code depicted above extracts the values found in the url, xdesc, and xtitle fields. The database preferably has additional fields such as 1) id and 2) subcat_id along with advertising banners, promotional information, sponsorship information, corresponding motion picture scene related information, etc.

“from url”

The above code provides the name of the table within the database from which to extract the information.

“where subcat_id=#url.id#”

The above code allows the EIAS server to distinguish which records to show. For this example, only records that have a subcat_id of 1 will be returned.

“ </cfquery> ”

The above code provides a closing tag. This tells the EIAS server that the given query process is finished and no more action is needed.

When a COLDFUSION page is executed, preferably all COLDFUSION code is configured to run first, the HTML code is preferably configured to subsequently run. This determines how the page will look to the user (as depicted in FIG. 7).

The following code facilitates display of the information gathered from the database via the above query. Preferably, use of the “cfoutput” tag is employed to facilitate information display:

```
            <cfloop query=“q1”>
            <cfoutput>
            <tr><td width=“390”><a href=“#url#” target=“_blank”
class=“urltitle”>#xtitle#</a><br><span
class=“small”>#xdesc#</span><br><span
class=“urldesc”>#url#</span><br><br></td></tr>
            </cfoutput>
            </cfloop>
```

This type of code facilitates what is commonly referred to as a “Dynamic” site. This allows for multiple bundles of information being displayed in a formatted body without having to repeat the process for each instance. Instead, the EIAS server will make as many lines of code needed to display all the record sets obtained via the query.

“ <cfloop query=“q1”> ”

The above code “loops” the results found via the query. By looping, the EIAS server knows to repeat the process equal to the amount of times that the value of subcat_id (1) is found within the database.

“ <cfoutput> ”

COLDFUSION uses the above tag to display associated variables. All COLDFUSION variables are distinguished by have pound signs (#) surrounding the variable.

“ <tr><td width=“390”><a href=“#url#” target=“_blank”
class=“urltitle”>#xtitle#</a><br><span
class=“small”>#xdesc#</span><br><span
class=“urldesc”>#url#</span><br><br></td></tr>”

The above code is the combined COLDFUSION and HTML code that results in what the user will see as depicted in FIG. 6. Not the variables with the pound signs encapsulating them. For this example, there are three records found for subcat_id. The user will see three sets of records, each relative to the value of subcat_id.

“ </cfoutput>, </cfloop> ”

The above code functions as the closing tags that tell the EIAS server to stop executing the code.

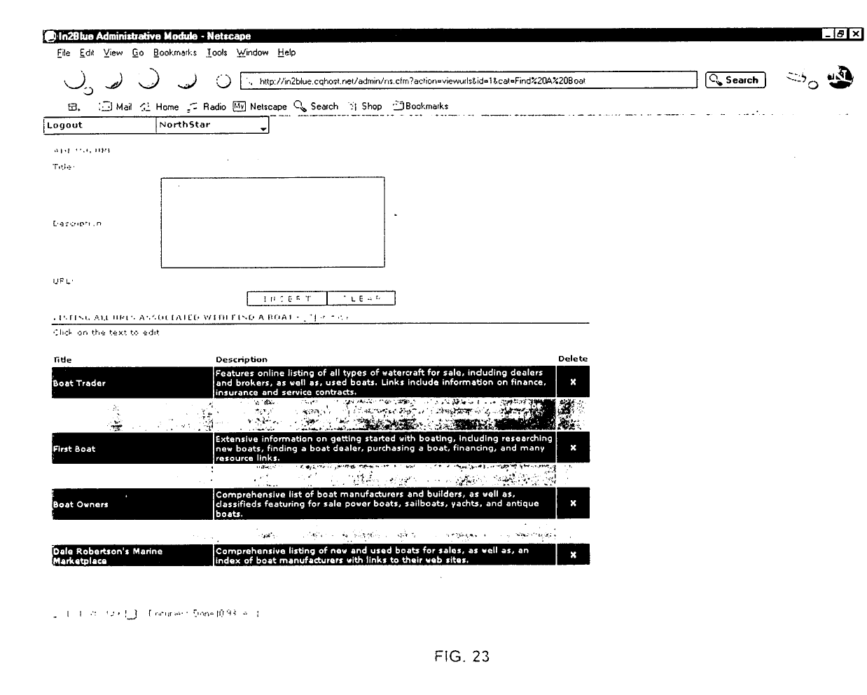

Turning now to FIGS. 22 and 23, there is depicted various fields of the associated database. A portion of the subject topics and sub-subject topics associated with the Diving NorthStar example EIAS are shown in FIG. 22. When a user selects one of the “categories” of the list of FIG. 22, the page of FIG. 23 is presented to allow a user to add an “URL”.

Preferably, the FLASH, COLDFUSION and SQL Server portions of the EIAS are integrated with an open database connectivity (ODBC) that facilitates interaction. SQL is an acronym for structured query language; when combined with ODBC an extremely flexible package is provided that allows the dynamic functionality desired in an EIAS.

In at least one EIAS embodiment, for example in the Diving NorthStar, the system is preferably configured such that when a user selects “Red Sea Diving”, for example, the EIAS server calls the page titled “ns.cfm.” The EIAS server then begins to read the code on that page. The code is preferably configured to instruct the EIAS server that it needs information from the database before it can be delivered. At this point, the EIAS server finds the database it needs, calls the ODBC driver and tells the database what it needs. The database queries the information and sends it back to the EIAS server via the ODBC. The EIAS server then has the information needed from the database and it displays the information in the form of a page as shown in FIG. 7.

It should be understood that the intrinsic order may be created and, or, structure may be provided to a subject domain utilizing at least one concept map hierarchy by: (a) mining site maps and the structure of credible web sites for the intrinsic order or structure; (b) mining existing structured data such as indexes, catalogues and other structured knowledge for the intrinsic order or structure; (c) using the dictionary and, or, thesaurus to find associated words, relationships and technical terms; and (d) consulting subject matter experts regarding the creation, accuracy and completeness of the intrinsic order and, or, structure. Software may be developed to “crawl” narrow portions of a network and, or, the internet to mine aforementioned structured environments and to help establish the development of the intrinsic order and, or, structure for the subject domain. In order to accelerate EIAS development, a central relational database may be created for storing substantially all, or all, data that will be used on the information links pages. Data models may be created that extract key information from related source documents and, or, internet sites, such as attributes, associations, relationships, linkage, various classifications of the data, synopsis, log line, text, image, people, author, title, publication, publication date, category, key words, size, etc. This database of data may then be used to help configure additional EIASs, based upon a particular theme and, or, concept. It is theoretically possible to create an EIAS that encompasses the entire internet. Alternatively, independent EIASs may be created to form a network of associated EIASs with a common theme; this EIAS network may ultimately become associated with other EIAS networks. At least one concept map may be dynamically configured, as there will be a need to regularly update it to reflect changes (additions, deletions or modifications) in the subject domain. This is especially true with regard to a collaborative or research environment. It is likely, that portions of one EIAS may be included in other EIAS(s). For example, the “Boating” section of the “Diving NorthStar” may be included, as is, in a “Fishing NorthStar.” It is possible to have different EIASs co-exist on the same subject, but from different perspectives and, or, with unique hierarchies. In an investigative, research environment, the EIAS may benefit from incorporation of pattern recognition software to sort through the related electronic data, looking for patterns and, or, anomalies and then setting forth the same on a related concept map. A future EIAS pertaining to an investigative, research or expert system, may set forth, explore, test and validate assumptions and, or, theories.

It should be understood that related commercial models may incorporate pay per click (PPC), pay for inclusion, pay for performance and other known revenue generation techniques individually, or, in combination. It should also be understood that individual copies of specific EIAS functions may be sold and, or, licenses may be negotiated to generate revenue. It should be understood that services may be provided for developing specific EIAS embodiments in return for compensation. Alternatively, agreements may be entered that provide for an interested party, or parties, to develop at least one EIAS associated with a given subject domain, or domains, at the expense of the developer. An EIAS commercial model may comprise assignment of at least a portion of related intellectual property in exchange for compensation.

Entities that currently develop software for electronic depiction of information associated with the various concept maps described herein, or similar to those described herein, such as, AutoDESK, AutoCAD, AutoCAD MAP, Design CAD, CADKEY, Intergraph Microstation, Arcinfo, ArcView, MapInfo, MapObjects, ArcIMS, SDE, ARC2MGE, ArcFM, ESRI, MetaMAP, TransCAD, TurboCAD, IntelliCAD, 3D CAD, CADpro, Pro/E, Parametric Tecynologies Corporation, Dassault Systemes, CATIA, Electronic Data Systems Corporation, Unigraphics, SDRC, I-deas, SolidWorks, etc. may negotiate a commercial model for incorporating at least one of the EIAS features described herein. Incorporation of a navigation interface in accordance with that of the present invention, within one of these packages, having mouse over selection functionality, would be advantageous. Incorporation of this type navigation interface within an electronic game, particularly an “interactive” online electronic game, would, as well, be advantageous.

In at least one embodiment, at least one motion picture is associated with at least one EIAS to form a commercial model. For example, a motion picture may comprise various individuals and, or, items; at least one related EIAS may provide access to electronic information related to the individual and, or, item. The individual and, or, item source may pay for inclusion and, or, per click. In such a commercial model, a version of the motion picture may be configured to be viewed within a viewing window and further configured to have at least one embedded electronic information link. The related EIAS may provide information for buying motion picture related items, such as action figures, making vacation plans to destinations depicted within the motion picture or accessing information regarding a specific actor, product placement, clothing, or prop featured in the motion picture.

In at least one commercial model, a theory of inventive problem solving (TRIZ is a Russian acronym) theories and techniques may be employed incorporating at least one EIAS. These endeavors may generate revenue by direct service or via licensing to develop law enforcement solutions and, or, investigations; public safety force response; emergency preparedness plans; decision trees; expert systems; research and development efforts; just-in-time manufacturing; just-in-time learning principals and techniques; theory of constraints (TOC) principles, techniques and trees; and, or, other collaborative efforts. It should be understood that when an EIAS is configured to facilitate a collaborative effort that multiple users may be interconnected such that real time information is communicated amongst a desired group. The related EIAS may be configured such that participants may directly access a related database and, or, enter data, as well as, links to important documents; alternatively, the participants could simply fill out structured reports with tags that would automatically update the database. U.S. Pat. No. 5,956,708, to Dyko et al., discloses an integration of link generation, cross-author user navigation, and reuse identification in authoring process, the entire disclosure of which is incorporated herein by reference.

Commercial models may comprise licensing of the EIAS technology to one or more search engine related companies. Alternatively, purchase of a search engine company for integration into an EIAS is envisioned.

In that a host of individual software has been disclosed for creating at least portions of a given EIAS, licenses may be negotiated with the various software companies disclosed herein for incorporation into their products.

The above description is considered that of the preferred embodiments. Modifications of the invention will occur to those skilled in the art and to those who make or use the invention. It should be understood that the embodiments shown in the drawings and described above are for illustrative purposes and not intended to limit the scope of the invention which is defined by the appended claims as interpreted according to the principles of patent law including the doctrine of equivalents.

1. An electronic information access system, comprising:
a concept map having a perimeter larger than a viewing window within which a portion of said concept map is viewable, said concept map and said viewing window are configured such that less than the entire concept map is visible at any given time; and
a navigation interface that allows a user to selectively position a desired portion of said concept map within said viewing window.

2. An electronic information access system as in claim 1, said navigation interface comprising at least eight-way, mouse-over, selection functionality.

3. An electronic information access system as in claim 2, said navigation interface comprising at least eight individual buttons, each button is associated with a unique navigation direction.

4. An electronic information access system as in claim 2, said navigation interface comprising at least eight unique areas within said viewing window, each of said areas is associated with a unique navigation direction.

5. An electronic information access system as in claim 1 wherein said viewing window comprises substantially all of, or all of, an associated browser window.

6. An electronic information access system as in claim 1 wherein said navigation interface is incorporated in a browser tool bar and, or, menu.

7. An electronic information access system as in claim 1 further comprising a border around at least a portion of said concept map.

8. An electronic information access system as in claim 7 wherein said border functions to indicate to a user that at least a portion of an edge of said concept map has been encountered.

9. An electronic information access system as in claim 1 further comprising a return to center button that allows a user to position a default portion of said concept map within said viewing window.

10. An electronic information access system as in claim 9, said return to center button comprising partially mouse-over and partially clickable selection functionality.

11. An electronic information access system as in claim 1, said concept map comprising at least one subject topic and, or, at least one sub-subject topic.

12. An electronic information access system as in claim 11 wherein said subject topic and, or, sub-subject topic is at least partially configured as a graphic, an image or text representation of an item selected from the group comprising: text with a background, an item within a motion picture, a person within a motion picture, a site within a motion picture, a product placement within a motion picture, a prop featured in a motion picture, clothing, an event, a plant, a vegetable, a medical symptom, an assumption, a problem, a solution, a building, a piece of equipment, a country, a state, a county, a municipality, a person, an animal, a road, a street, an alley, a highway, a route, a trail, a path, a creek, a mountain, an island, a file, a note, a grocery store, a field, a barn, a green house, a lawyer, an accountant, a broker, a consultant, a contractor, an engineer, a doctor, an architect, a hospital, a radio station, a university, a college, a school, a factory, a farm, a ranch, a field, a team, a football team, a basketball team, a baseball team, a soccer team, a track and field team, a television station, a radio station, a museum, a garden, a park, an ocean, a lake, an airplane, a boat, a train, a ship, a cruise ship, an airport, a line, a port, a house, a record, a musician, an artist, an actor, an actress, an athlete, a patent, a patent application, a book, a magazine, a patient, a thesis, a dissertation, a computer, a telephone, a pager, a pump station, a tank, a compressor station, a generating facility, a well head, a drilling platform, a substation, a transmission line, a pipeline, a pipe, a wire, a fiber optic line, a coaxial cable, a radio frequency link, a transmitter, a receiver, an arena, a stadium, a national forest, GPS coordinates, research leads, investigative leads, a gas station, a club, an association, a convenience store, a hotel, a hotel room, a restaurant, a restaurant menu, a retail store, a mall, a warehouse, a sewer treatment plant, an office building, a water treatment plant, a newspaper, a pet, a car, a truck, a piece of real property, a marina, an audio recording, a video recording, an appliance, an aquarium, a motion picture, a bank, an ATM, an account, a customer, and an address.

13. An electronic information access system as in claim 11 wherein at least one of said subject topics has a GO TO button associated therewith that allows a user to position a second subject topic, which is located elsewhere within said concept map, near a center portion of said viewing window.

14. An electronic information access system as in claim 13 wherein a border of said second subject topic at least momentarily changes color substantially immediately following activation of said GO TO button.

15. An electronic information access system as in claim 1, said concept map comprising at least one sub-subject topic.

16. An electronic information access system as in claim 15 wherein at least one of said sub-subject topics has a GO TO button associated therewith that allows a user to position a second sub-subject topic, which is located elsewhere within said concept map, near a center portion of said viewing window.

17. An electronic information access system as in claim 16 wherein a border of said second sub-subject topic at least momentarily changes color substantially immediately following activation of a said GO TO button.

18. An electronic information access system as in claim 1 further comprising an about button.

19. An electronic information access system as in claim 18 wherein said about button is configured with partially mouse-over and partially clickable selection functionality.

20. An electronic information access system as in claim 1 further comprising at least one advertising banner.

21. An electronic information access system as in claim 1 further comprising at least one user selectable tool bar item.

22. An electronic information access system as in claim 21 wherein said at least one user selectable tool bar item has at least one user selectable menu item associated therewith.

23. An electronic information access system as in claim 1 wherein said concept map is configured to move with respect to said viewing window.

24. An electronic information access system as in claim 1 wherein said viewing window is configured to move with respect to said concept map.

25. An electronic information access system as in claim 1 wherein said concept map is selected from a group comprising: a subject domain, a motion picture, sports tournament bracket, at least one facility, road map, map, geological map, sub-division map, building plan, architectural plan, at least one solar system, at least one planet, a world map, at least one continent, at least one country, at least one state, at least one municipality, air flight routes, hiking trails, bike paths, high school football, golfing, gardening, sports, at least on team, at least one athlete, card tournament, information related to at least one person, skiing related information, corporate operations, corporate facilities, a heating system, an air conditioning system, a ventilation system, decision tree, future scenario tree, social network, expert system, just-in-time learning system, just-in-time manufacturing system, theory of constraints system, medical expert system, legal expert system, emergency preparedness plan, at least one creek, at least one mountain, at least one island, a file management system, a note management system, a docketing system, a collaborative effort, a research effort, a TRIZ effort, a mining operation, a garbage company, a grocery company, an agricultural operation, a forestry operation, an employment agency, an office building, a campus, a vehicle manufacturer, vehicle sales company, law firm, an accounting firm, a church, a camping area, a night club, at least one bookstore, a military operation, a satellite system, a mail route, a travel agency, a restaurant company, a shopping mall, a warehouse company, a fitness operation company, a library, a genealogy chart, banquet facility, furniture company, oil company, gasoline retail operation, grain elevator, pet store, vehicle rental company, vehicle repair company, at least one product catalog, corporate personnel, personal household records, product sales and marketing, intellectual property portfolios, a project management system, a calendar of events, plants, vegetables, collaborative system, educational materials, medical information, research projects, geographic information system (GIS), a tax map, Auditor's records, rail roads, bus lines, cruise ship lines, subway systems, air travel, shipping routes, electric utility, transmission system, natural gas, pipeline system, water utility, sewer utility, telecommunication system, a computer system, cable television system, entertainment guide, television viewing guide, news summary, log line, at least one library, at least one museum, at least one art center, at least one sports complex, at least one entertainment facility, telephone system, internet service provider, fiber optic lines, at least one financial institution, at least one banking company, at least one automatic teller machine (ATM), at least one insurance company, at least one credit card company, at least one hotel, at least one resort, at least one park, at least one ocean, at least one sea, at least one lake and at least one river.

26. An electronic information access system as in claim 1 further configured to provide access to at least one of the items selected from a group comprising: license options, reservation options, contract options, purchase options, ticket options, payment options, account information and billing.

27. An electronic information access system as in claim 1 further comprising at least one of the items selected from a group comprising: a personal digital assistant (PDA), a Palm Pilot, a personal computer, a laptop computer, a camera, a printer, a scanner, a copier, a video recorder, an electronic game player, a local area network, a wide area network, a router, a hub, an audio recorder, a video player, an audio player, a direct video device (DVD) player, a DVD recorder, a network server, a main frame, a terminal, an intranet, email, an internet connection, a microphone, a speaker, a mouse, a pointing device, a monitor, a touch sensitive screen, a television, a cellular telephone, an OnStar type device, pagers, a floppy disk, a hard disk, a memory stick, a zip drive, a compact disk (CD), a DVD, a tape, a media player, a memory chip, and a USB compatible device.

28. An electronic information access system as in claim 1 wherein said concept map is three dimensional.

29. An electronic information access system, comprising:
a concept map viewable within a viewing window, said concept map comprising at least one GO TO button.

30. An electronic information access system as in claim 29, said concept map comprising at least one subject topic.

31. An electronic information access system as in claim 30 wherein said subject topic and, or, sub-subject topic is at least partially configured as a graphic, image or text representation of an item selected from the group comprising: text with a background, an item within a motion picture, a person within a motion picture, a site within a motion picture, a product placement within a motion picture, a prop featured in a motion picture, clothing, an event, a plant, a vegetable, a medical symptom, an assumption, a problem, a solution, a building, a piece of equipment, a country, a state, a county, a municipality, a person, an animal, a road, a street, an alley, a highway, a route, a trail, a path, a creek, a mountain, an island, a file, a note, a grocery store, a field, a barn, a green house, a lawyer, an accountant, a broker, a consultant, a contractor, an engineer, a doctor, an architect, a hospital, a radio station, a university, a college, a school, a factory, a farm, a ranch, a field, a team, a football team, a basketball team, a baseball team, a soccer team, a track and field team, a television station, a radio station, a museum, a garden, a park, an ocean, a lake, an airplane, a boat, a train, a ship, a cruise ship, an airport, a line, a port, a house, a record, a musician, an artist, an actor, an actress, an athlete, a patent, a patent application, a book, a magazine, a patient, a thesis, a dissertation, a computer, a telephone, a pager, a pump station, a tank, a compressor station, a generating facility, a well head, a drilling platform, a substation, a transmission line, a pipeline, a pipe, a wire, a fiber optic line, a coaxial cable, a radio frequency link, a transmitter, a receiver, an arena, a stadium, a national forest, GPS coordinates, research leads, investigative leads, a gas station, a club, an association, a convenience store, a hotel, a hotel room, a restaurant, a restaurant menu, a retail store, a mall, a warehouse, a sewer treatment plant, an office building, a water treatment plant, a newspaper, a pet, a car, a truck, a piece of real property, a marina, an audio recording, a video recording, an appliance, an aquarium, a motion picture, a bank, an ATM, an account, a customer, and an address.

32. An electronic information access system as in claim 30 wherein at least one of said subject topics has a GO TO button associated therewith that allows a user to position a second subject topic, which is located elsewhere within said concept map, near a center portion of said viewing window.

33. An electronic information access system as in claim 32 wherein a border of said second subject topic at least momentarily changes color substantially immediately following activation of said GO TO button.

34. An electronic information access system as in claim 29, said concept map comprising at least one of sub-subject topic.

35. An electronic information access system as in claim 34 wherein at least one of said sub-subject topics has a GO TO button associated therewith that allows a user to position a second sub-subject topic, which is located elsewhere within said concept map, near a center portion of said viewing window.

36. An electronic information access system as in claim 35 wherein a border of said second sub-subject topic at least momentarily changes color substantially immediately following activation of said GO TO button.

37. An electronic information access system as in claim 29 wherein said concept map is configured to move with respect to said viewing window.

38. An electronic information access system as in claim 29 wherein said viewing window is configured to move with respect to said concept map.

39. An electronic information access system as in claim 29 wherein said concept map is selected from a group comprising: a subject domain, a motion picture, sports tournament bracket, at least one facility, road map, map, geological map, sub-division map, building plan, architectural plan, at least one solar system, at least one planet, a world map, at least one continent, at least one country, at least one state, at least one municipality, air flight routes, hiking trails, bike paths, high school football, golfing, gardening, sports, at least one team, at least one athlete, card tournament, information related to at least one person, skiing related information, corporate operations, corporate facilities, a heating system, an air conditioning system, a ventilation system, decision tree, future scenario tree, social network, expert system, just-in-time learning system, just-in-time manufacturing system, theory of constraints system, medical expert system, legal expert system, emergency preparedness plan, at least one creek, at least one mountain, at least one island, a file management system, a note management system, a docketing system, a collaborative effort, a research effort, a TRIZ effort, a mining operation, a garbage company, a grocery company, an agricultural operation, a forestry operation, an employment agency, an office building, a campus, a vehicle manufacturer, vehicle sales company, law firm, an accounting firm, a church, a camping area, a night club, at least one bookstore, a military operation, a satellite system, a mail route, a travel agency, a restaurant company, a shopping mall, a warehouse company, a fitness operation company, a library, a genealogy chart, banquet facility, furniture company, oil company, gasoline retail operation, grain elevator, pet store, vehicle rental company, vehicle repair company, at least one product catalog, corporate personnel, personal household records, product sales and marketing, intellectual property portfolios, a project management system, a calendar of events, plants, vegetables, collaborative system, educational materials, medical information, research projects, geographic information system (GIS), a tax map, Auditor's records, rail roads, bus lines, cruise ship lines, subway systems, air travel, shipping routes, electric utility, transmission system, natural gas, pipeline system, water utility, sewer utility, telecommunication system, a computer system, cable television system, entertainment guide, television viewing guide, news summary, log line, at least one library, at least one museum, at least one art center, at least one sports complex, at least one entertainment facility, telephone system, internet service provider, fiber optic lines, at least one financial institution, at least one banking company, at least one automatic teller machine (ATM), at least one insurance company, at least one credit card company, at least one hotel, at least one resort, at least one park, at least one ocean, at least one sea, at least one lake and at least one river.

40. An electronic information access system as in claim 29 further configured to provide access to at least one of the items selected from a group comprising: license options, reservation options, contract options, purchase options, ticket options, payment options, account information and billing.

41. An electronic information access system as in claim 29 further comprising at least one of the items selected from a group comprising: a personal digital assistant (PDA), a Palm Pilot, a personal computer, a laptop computer, a camera, a printer, a scanner, a copier, a video recorder, an electronic game player, a local area network, a wide area network, a router, a hub, an audio recorder, a video player, an audio player, a direct video device (DVD) player, a DVD recorder, a network server, a main frame, a terminal, an intranet, email, an internet connection, a microphone, a speaker, a mouse, a pointing device, a monitor, a touch sensitive screen, a television, a cellular telephone, OnStar type device, pagers, a floppy disk, a hard disk, a memory stick, a zip drive, a compact disk (CD), a DVD, a tape, a media player, a memory chip, and a USB compatible device.

42. An electronic information access system as in claim 29 wherein said concept map is three dimensional.

43. An electronic information access system, comprising:
a concept map having a perimeter larger than a viewing window within which said concept map is viewable, said concept map and said viewing window are configured such that less than the entire concept map is visible at any given time;
a navigation interface that allows a user to selectively position a desired portion of said concept map within said viewing window;
a return to center button that allows a user to position a default portion of said concept map within said viewing window;
an about button; and
at least one GO TO button.

44. An electronic information access system as in claim 43, said navigation interface comprising at least eight-way, mouse-over, selection functionality.

45. An electronic information access system as in claim 43, said return to center button comprising partially mouse-over and partially clickable selection functionality.

46. An electronic information access system as in claim 43, said about button comprising partially mouse-over and partially clickable selection functionality.

47. An electronic information access system as in claim 43, said GO TO button comprising partially mouse-over and partially clickable selection functionality.

48. An electronic information access system as in claim 43 further comprising at least one subject topic and, or, at least one sub-subject topic, wherein said subject topic and, or, sub-subject topic is at least partially configured as a graphic, image or text representation of an item selected from the group comprising: text with a background, an item within a motion picture, a person within a motion picture, a site within a motion picture, a product placement within a motion picture, a prop featured in a motion picture, clothing, an event, a plant, a vegetable, a medical symptom, an assumption, a problem, a solution, a building, a piece of equipment, a country, a state, a county, a municipality, a person, an animal, a road, a street, an alley, a highway, a route, a trail, a path, a creek, a mountain, an island, a file, a note, a grocery store, a field, a barn, a green house, a lawyer, an accountant, a broker, a consultant, a contractor, an engineer, a doctor, an architect, a hospital, a radio station, a university, a college, a school, a factory, a farm, a ranch, a field, a team, a football team, a basketball team, a baseball team, a soccer team, a track and field team, a television station, a radio station, a museum, a garden, a park, an ocean, a lake, an airplane, a boat, a train, a ship, a cruise ship, an airport, a line, a port, a house, a record, a musician, an artist, an actor, an actress, an athlete, a patent, a patent application, a book, a magazine, a patient, a thesis, a dissertation, a computer, a telephone, a pager, a pump station, a tank, a compressor station, a generating facility, a well head, a drilling platform, a substation, a transmission line, a pipeline, a pipe, a wire, a fiber optic line, a coaxial cable, a radio frequency link, a transmitter, a receiver, an arena, a stadium, a national forest, GPS coordinates, research leads, investigative leads, a gas station, a club, an association, a convenience store, a hotel, a hotel room, a restaurant, a restaurant menu, a retail store, a mall, a warehouse, a sewer treatment plant, an office building, a water treatment plant, a newspaper, a pet, a car, a truck, a piece of real property, a marina, an audio recording, a video recording, an appliance, an aquarium, a motion picture, a bank, an ATM, an account, a customer, and an address.

49. An electronic information access system as in claim 43 wherein said concept map is selected from a group comprising: a subject domain, a motion picture, sports tournament bracket, at least one facility, road map, map, geological map, sub-division map, building plan, architectural plan, at least one solar system, at least one planet, a world map, at least one continent, at least one country, at least one state, at least one municipality, air flight routes, hiking trails, bike paths, high school football, golfing, gardening, sports, at least one team, at least one athlete, card tournament, information related to at least one person, skiing related information, corporate operations, corporate facilities, a heating system, an air conditioning system, a ventilation system, decision tree, future scenario tree, social network, expert system, just-in-time learning system, just-in-time manufacturing system, theory of constraints system, medical expert system, legal expert system, emergency preparedness plan, at least one creek, at least one mountain, at least one island, a file management system, a note management system, a docketing system, a collaborative effort, a research effort, a TRIZ effort, a mining operation, a garbage company, a grocery company, an agricultural operation, a forestry operation, an employment agency, an office building, a campus, a vehicle manufacturer, vehicle sales company, law firm, an accounting firm, a church, a camping area, a night club, at least one bookstore, a military operation, a satellite system, a mail route, a travel agency, a restaurant company, a shopping mall, a warehouse company, a fitness operation company, a library, a genealogy chart, banquet facility, furniture company, oil company, gasoline retail operation, grain elevator, pet store, vehicle rental company, vehicle repair company, at least one product catalog, corporate personnel, personal hous hold records, product sales and marketing, intellectual property portfolios, a project management system, a calendar of events, plants, vegetables, collaborative system, educational materials, medical information, research projects, geographic information system (GIS), a tax map, Auditor's records, rail roads, bus lines, cruise ship lines, subway systems, air travel, shipping routes, electric utility, transmission system, natural gas, pipeline system, water utility, sewer utility, telecommunication system, a computer system, cable television system, entertainment guide, television viewing guide, news summary, log line, at least one library, at least one museum, at least one art center, at least one sports complex, at least one entertainment facility, telephone system, internet service provider, fiber optic lines, at least one financial institution, at least one banking company, at least one automatic teller machine (ATM), at least one insurance company, at least one credit card company, at least one hotel, at least one resort, at least one park, at least one ocean, at least one sea, at least one lake and at least one river.

50. An electronic information access system as in claim 43 further configured to provide access to at least one of the items selected from a group comprising: license options, reservation options, contract options, purchase options, ticket options, payment options, account information and billing.

51. An electronic information access system as in claim 43 further comprising at least one of the items selected from a group comprising: a personal digital assistant (PDA), a Palm Pilot, a personal computer, a laptop computer, a camera, a printer, a scanner, a copier, a video recorder, an electronic game player, a local area network, a wide area network, a router, a hub, an audio recorder, a video player, an audio player, a direct video device (DVD) player, a DVD recorder, a network server, a main frame, a terminal, an intranet, email, an internet connection, a microphone, a speaker, a mouse, a pointing device, a monitor, a touch sensitive screen, a television, a cellular telephone, OnStar type device, pagers, a floppy disk, a hard disk, a memory stick, a zip drive, a compact disk (CD), a DVD, a tape, a media player, a memory chip, and a USB compatible device.

52. An electronic information access system as in claim 43 wherein said concept map is three dimensional.

53. An electronic information access system, comprising:
a concept map based visual interface dynamically linked to underlying electronic information.

54. An electronic information access system as in claim 53 wherein at least a portion is created utilizing FLASH.

55. An electronic information access system as in claim 53 wherein at least a portion is created utilizing JAVA.

56. An electronic information access system as in claim 53 wherein at least a portion is created utilizing COLDFUSION.

57. An electronic information access system as in claim 53 wherein at least a portion is created utilizing SQL server.

58. An electronic information access system as in claim 53 wherein at least a portion is created utilizing HTML.

59. An electronic information access system as in claim 53 further comprising at least one subject topic and, or, at least one sub-subject topic, wherein said subject topic and, or, sub-subject topic is at least partially configured as a graphic, image or text representation of an item selected from the group comprising: text with a background, an item within a motion picture, a person within a motion picture, a site within a motion picture, a product placement within a motion picture, a prop featured in a motion picture, clothing, an event, a plant, a vegetable, a medical symptom, an assumption, a problem, a solution, a building, a piece of equipment, a country, a state, a county, a municipality, a person, an animal, a road, a street, an alley, a highway, a route, a trail, a path, a creek, a mountain, an island, a file, a note, a grocery store, a field, a barn, a green house, a lawyer, an accountant, a broker, a consultant, a contractor, an engineer, a doctor, an architect, a hospital, a radio station, a university, a college, a school, a factory, a farm, a ranch, a field, a team, a football team, a basketball team, a baseball team, a soccer team, a track and field team, a television station, a radio station, a museum, a garden, a park, an ocean, a lake, an airplane, a boat, a train, a ship, a cruise ship, an airport, a line, a port, a house, a record, a musician, an artist, an actor, an actress, an athlete, a patent, a patent application, a book, a magazine, a patient, a thesis, a dissertation, a computer, a telephone, a pager, a pump station, a tank, a compressor station, a generating facility, a well head, a drilling platform, a substation, a transmission line, a pipeline, a pipe, a wire, a fiber optic line, a coaxial cable, a radio frequency link, a transmitter, a receiver, an arena, a stadium, a national forest, GPS coordinates, research leads, investigative leads, a gas station, a club, an association, a convenience store, a hotel, a hotel room, a restaurant, a restaurant menu, a retail store, a mall, a warehouse, a sewer treatment plant, an office building, a water treatment plant, a newspaper, a pet, a car, a truck, a piece of real property, a marina, an audio recording, a video recording, an appliance, an aquarium, a motion picture, a bank, an ATM, an account, a customer, and an address.

60. An electronic information access system as in claim 53 wherein said concept map is selected from a group comprising: a subject domain, a motion picture, sports tournament bracket, at least one facility, road map, map, geological map, sub-division map, building plan, architectural plan, at least one solar system, at least one planet, a world map, at least one continent, at least one country, at least one state, at least one municipality, air flight routes, hiking trails, bike paths, high school football, golfing, gardening, sports, at least one team, at least one athlete, card tournament, information related to at least one person, skiing related information, corporate operations, corporate facilities, a heating system, an air conditioning system, a ventilation system, decision tree, future scenario tree, social network, expert system, just-in-time learning system, just-in-time manufacturing system, theory of constraints system, medical expert system, legal expert system, emergency preparedness plan, at least one creek, at least one mountain, at least one island, a file management system, a note management system, a docketing system, a collaborative effort, a research effort, a TRIZ effort, a mining operation, a garbage company, a grocery company, an agricultural operation, a forestry operation, an employment agency, an office building, a campus, a vehicle manufacturer, vehicle sales company, law firm, an accounting firm, a church, a camping area, a night club, at least one bookstore, a military operation, a satellite system, a mail route, a travel agency, a restaurant company, a shopping mall, a warehouse company, a fitness operation company, a library, a genealogy chart, banquet facility, furniture company, oil company, gasoline retail operation, grain elevator, pet store, vehicle rental company, vehicle repair company, at least one product catalog, corporate personnel, personal household records, product sales and marketing, intellectual property portfolios, a project management system, a calendar of events, plants, vegetables, collaborative system, educational materials, medical information, research projects, geographic information system (GIS), a tax map, Auditor's records, rail roads, bus lines, cruise ship lines, subway systems, air travel, shipping routes, electric utility, transmission system, natural gas, pipeline system, water utility, sewer utility, telecommunication system, a computer system, cable television system, entertainment guide, television viewing guide, news summary, log line, at least one library, at least one museum, at least one art center, at least one sports complex, at least one entertainment facility, telephone system, internet service provider, fiber optic lines, at least one financial institution, at least one banking company, at least one automatic teller machine (ATM), at least one insurance company, at least one credit card company, at least one hotel, at least one resort, at least one park, at least one ocean, at least one sea, at least one lake and at least one river.

61. An electronic information access system as in claim 53 further configured to provide access to at least one of the items selected from a group comprising: license options, reservation options, contract options, purchase options, ticket options, payment options, account information and billing.

62. An electronic information access system as in claim 53 further comprising at least one of the items selected from a group comprising: a personal digital assistant (PDA), a Palm Pilot, a personal computer, a laptop computer, a camera, a printer, a scanner, a copier, a video recorder, an electronic game player, a local area network, a wide area network, a router, a hub, an audio recorder, a video player, an audio player, a direct video device (DVD) player, a DVD recorder, a network server, a main frame, a terminal, an intranet, email, an internet connection, a microphone, a speaker, a mouse, a pointing device, a monitor, a touch sensitive screen, a television, a cellular telephone, OnStar type device, pagers, a floppy disk, a hard disk, a memory stick, a zip drive, a compact disk (CD), a DVD, a tape, a media player, a memory chip, and a USB compatible device.

63. An electronic information access system, comprising:
a concept map based visual interface configured to load quickly upon initiation by a user.

64. An electronic information access system as in claim 63 wherein said concept map is at least partially created utilizing vector based graphics.

65. An electronic information access system as in claim 63 further comprising at least one sub-subject topic.

66. An electronic information access system as in claim 65 wherein said at least one sub-subject topic is created utilizing a FLASH button symbol.

67. An electronic information access system as in claim 63 further comprising at least one subject topic and, or, at least one sub-subject topic, wherein said subject topic and, or, sub-subject topic is at least partially configured as a graphic, image or text representation of an item selected from the group comprising: text with a background, an item within a motion picture, a person within a motion picture, a site within a motion picture, a product placement within a motion picture, a prop featured in a motion picture, clothing, an event, a plant, a vegetable, a medical symptom, an assumption, a problem, a solution, a building, a piece of equipment, a country, a state, a county, a municipality, a person, an animal, a road, a street, an alley, a highway, a route, a trail, a path, a creek, a mountain, an island, a file, a note, a grocery store, a field, a barn, a green house, a lawyer, an accountant, a broker, a consultant, a contractor, an engineer, a doctor, an architect, a hospital, a radio station, a university, a college, a school, a factory, a farm, a ranch, a field, a team, a football team, a basketball team, a baseball team, a soccer team, a track and field team, a television station, a radio station, a museum, a garden, a park, an ocean, a lake, an airplane, a boat, a train, a ship, a cruise ship, an airport, a line, a port, a house, a record, a musician, an artist, an actor, an actress, an athlete, a patent, a patent application, a book, a magazine, a patient, a thesis, a dissertation, a computer, a telephone, a pager, a pump station, a tank, a compressor station, a generating facility, a well head, a drilling platform, a substation, a transmission line, a pipeline, a pipe, a wire, a fiber optic line, a coaxial cable, a radio frequency link, a transmitter, a receiver, an arena, a stadium, a national forest, GPS coordinates, research leads, investigative leads, a gas station, a club, an association, a convenience store, a hotel, a hotel room, a restaurant, a restaurant menu, a retail store, a mall, a warehouse, a sewer treatment plant, an office building, a water treatment plant, a newspaper, a pet, a car, a truck, a piece of real property, a marina, an audio recording, a video recording, an appliance, an aquarium, a motion picture, a bank, an ATM, an account, a customer, and an address.

68. An electronic information access system as in claim 63 wherein said concept map is selected from a group comprising: a subject domain, a motion picture, sports tournament bracket, at least one facility, road map, map, geological map, sub-division map, building plan, architectural plan, at least one solar system, at least one planet, a world map, at least one continent, at least one country, at least one state, at least one municipality, air flight routes, hiking trails, bike paths, high school football, golfing, gardening, sports, at least one team, at least one athlete, card tournament, information related to at least one person, skiing related information, corporate operations, corporate facilities, a heating system, an air conditioning system, a ventilation system, decision tree, future scenario tree, social network, expert system, just-in-time learning system, just-in-time manufacturing system, theory of constraints system, medical expert system, legal expert system, emergency preparedness plan, at least one creek, at least one mountain, at least one island, a file management system, a note management system, a docketing system, a collaborative effort, a research effort, a TRIZ effort, a mining operation, a garbage company, a grocery company, an agricultural operation, a forestry operation, an employment agency, an office building, a campus, a vehicle manufacturer, vehicle sales company, law firm, an accounting firm, a church, a camping area, a night club, at least one bookstore, a military operation, a satellite system, a mail route, a travel agency, a restaurant company, a shopping mall, a warehouse company, a fitness operation company, a library, a genealogy chart, banquet facility, furniture company, oil company, gasoline retail operation, grain elevator, pet store, vehicle rental company, vehicle repair company, at least one product catalog, corporate personnel, personal household records, product sales and marketing, intellectual property portfolios, a project management system, a calendar of events, plants, vegetables, collaborative system, educational materials, medical information, research projects, geographic information system (GIS), a tax map, Auditor's records, rail roads, bus lines, cruise ship lines, subway systems, air travel, shipping routes, electric utility, transmission system, natural gas, pipeline system, water utility, sewer utility, telecommunication system, a computer system, cable television system, entertainment guide, television viewing guide, news summary, log line, at least one library, at least one museum, at least one art center, at least one sports complex, at least one entertainment facility, telephone system, internet service provider, fiber optic lines, at least one financial institution, at least on banking company, at least one automatic teller machine (ATM), at least one insurance company, at least one credit card company, at least one hotel, at least one resort, at least one park, at least one ocean, at least one sea, at least one lake and at least one river.

69. An electronic information access system as in claim 63 further configured to provide access to at least one of the items selected from a group comprising: license options, reservation options, contract options, purchase options, ticket options, payment options, account information and billing.

70. An electronic information access system as in claim 63 further comprising at least one of the items selected from a group comprising: a personal digital assistant (PDA), a Palm Pilot, a personal computer, a laptop computer, a camera, a printer, a scanner, a copier, a video recorder, an electronic game player, a local area network, a wide area network, a router, a hub, an audio recorder, a video player, an audio player, a direct video device (DVD) player, a DVD recorder, a network server, a main frame, a terminal, an intranet, email, an internet connection, a microphone, a speaker, a mouse, a pointing device, a monitor, a touch sensitive screen, a television, a cellular telephone, OnStar type device, pagers, a floppy disk, a hard disk, a memory stick, a zip drive, a compact disk (CD), a DVD, a tape, a media player, a memory chip, and a USB compatible device.

71. An electronic drawing creation system, comprising:
a viewing window for presentation of at least a portion of an electronic drawing to a user; and
a mouse over navigation interface that allows a user to selectively position said electronic drawing within said viewing window.

72. An electronic drawing creation system as in claim 71 selected from the group comprising: AutoDESK, AutoCAD, AutoCAD MAP, Design CAD, CADKEY, Integraph Microstation, ArcView, Arcinfo, MapInfo, MapObjects, ArcIMS, SDE, ARC2MGE, ArcFM, ESRI, MetaMAP, TransCAD, TurboCAD, IntelliCAD, 3D CAD, CADpro, Pro/E, Parametric Tecynologies Corporation, Dassault Systemes, CATIA, Electronic Data Systems Corporation, Unigraphics, SDRC, I-deas, SolidWorks, Photoshop, Adobe Illustrator, and FIREWORKS.

73. An internet based electronic game, comprising:
a mouse over navigation interface that allows a user to selectively position a scene on a related display.
